(19) United States
(12) Patent Application Publication
(10) Pub. No.: US 2011/0227952 A1
(43) Pub. Date: Sep. 22, 2011

(54) DISPLAY POSITION SETTING DEVICE

(75) Inventor: Kenichi HAMAGUCHI, Kariya-city (JP)

(73) Assignee: DENSO CORPORATION, Kariya-city (JP)

(21) Appl. No.: 13/045,385

(22) Filed: Mar. 10, 2011

(30) Foreign Application Priority Data
Mar. 16, 2010 (JP) 2010-59491
Dec. 8, 2010 (JP) 2010-273848

(51) Int. Cl. G09G 5/00

(52) U.S. Cl. 345/672

(57) ABSTRACT

A display position setting device includes: an obtaining element for obtaining positioning condition information which provides an arrangement of an image item on a screen of a display device according to an interface condition, wherein the image item is a batch of various information; a reading element for reading out the image item together with content information and position information from a memory, wherein the content information provides content of the image item, and the position information provides a position of the image item on the screen of the display device; a converting element for converting the position information based on the positioning condition information; and a display controller for controlling the display device to display the content information at a position, which is specified by converted position information.

### CROSS REFERENCE TO RELATED APPLICATION

This application is based on Japanese Patent Applications No. 2010-59491 filed on Mar. 16, 2010, and No. 2010-273848 filed on Dec. 8, 2010 the disclosures of which are incorporated herein by reference.

### TECHNICAL FIELD

The present invention relates to a display position setting device for setting an arrangement of various information displayed on a screen according to conditions of an interface.

### BACKGROUND

Electric equipment such as a navigation device, a personal computer, a smart phone and a cell phone has a display panel, and a processor controls the display panel to display various information on a screen of the display panel. When the display panel displays the information, image, items such as an image and a text as a batch of information for providing individual information items include not only contents of the information but also positioning information for setting an arrangement of the information on the screen. The processor controls the display device to display the image elements at certain positions on the screen according to the positioning information.

Here, when the various information is displayed on the screen of the display device, it is preferable to arrange the image items in view of the conditions of the interface, i.e. the environmental conditions of the interface. For example, when the environmental conditions provide that a sentence is read from a left side to a right side in a language such as Japanese and English, a term “YES” is arranged on the left side, and a term “NO” is arranged on the right side, in general. When the environmental conditions provide that a sentence is read from a right side to a left side in a language such as Arabic, Persian and Hebrew, it is convenient for an user to arrange the term “YES” on the right side and the term “NO” on the left side. Here, a device for inputting a sentence or a word in Arabic is disclosed in, for example, JP-A-H10-31471.

Thus, the arrangement of the image items depends on the environment of the interface. Specifically, the appropriate arrangement of the image items under certain interface condition may be different from another interface condition. In this case, it is necessary to re-arrange the image items on the screen in view of the interface condition.

Conventionally, in a technique for changing the arrangement of the items according to the interface condition, various positioning information according to multiple interface conditions are attached to each image item, and the positioning information is stored in a memory.

However, in the above conventional technique, it is necessary to store various positioning information of each image item corresponding to multiple interface conditions. Thus, an area of use of the memory increases.

Specifically, each image item such as image data and text data includes position information in case of Arabic and position information in case of English, so that two types of positioning information are stored in the memory. Thus, the area of use of the memory increases.

### SUMMARY

In view of the above-described problem, it is an object of the present disclosure to provide a display position setting device for setting an arrangement of various information displayed on a screen according to environmental conditions of an interface without increasing an area of use in a memory.

According to a first aspect of the present disclosure, a display position setting device includes: an obtaining element for obtaining positioning condition information, which provides an arrangement of an image item on a screen of a display device according to an interface condition, wherein the image item is a batch of various information; a reading element for reading out the image item together with content information and position information from a memory, wherein the content information provides content of the image item, and the position information provides a position of the image item on the screen of the display device; a converting element for converting the position information based on the positioning condition information; and a display controller for controlling the display device to display the content information at a position, which is specified by converted position information.

In the above display position setting device, since the position information is reset, i.e., converted according to the positioning condition information, it is not necessary to store a large amount of position information corresponding to the image items. Thus, without increasing the area of use of the memory, the image item is arranged on the screen according to, the interface condition.

According to a second aspect of the present disclosure, a position setting device includes: an image information obtaining element for obtaining image information; a display direction information obtaining element for obtaining display direction information, which shows whether the image information is directly displayed on a display device, or mirror reversed and displayed on the display device; and a display controller for controlling the display device to display the image information along with a direction specified by the display direction information.

In the above device, even when the language system is the read-right-to-left language it is not necessary to add a calculation process for calculating new coordinates. Thus, the device can execute a display position setting process with high speed.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing a navigation system according to a first embodiment;

FIGS. 2A and 2B are diagrams showing examples of image items displayed on a screen of a display device according to the first embodiment;

FIG. 3A is a diagram showing a: screen image of the displayed device, and

FIG. 3B is a diagram showing a data format corresponding to the screen image;

FIG. 4 is a flowchart showing a first display position setting process executed by a controller according to the first embodiment;

FIGS. 5A and 5B are diagrams showing examples of image items displayed on the screen of the display device according to a second embodiment;

FIG. 6A is a diagram showing a screen image of the displayed device, and

FIG. 6B is a diagram showing a data format corresponding to the screen image according to the second embodiment;

FIG. 7 is a flowchart showing a second display position setting process executed by the controller according to the second embodiment;

FIGS. 8A to 8C are diagrams showing examples of image items displayed on the screen of the display device according to a third embodiment;

FIG. 9A is a diagram showing a screen image of the displayed device and

FIG. 9B is a diagram showing a data format corresponding to the screen image, according to the third embodiment;

FIG. 10 is a flowchart showing a third display position setting process executed by the controller according to the third embodiment;

FIG. 11A is a flowchart showing a fourth display position setting process executed by the controller, and FIG. 11B is a flowchart showing a first display process according to a fourth embodiment;

FIGS. 12A-12C are diagrams showing a correspondence relationship among image data in an image database stored in an external memory, a display region of a VRAM and a display region of the display device;

FIG. 13 is a diagram showing a correspondence relationship among the image data, the display region of the VRAM and the display region of the display device in the fourth display position setting process;

FIG. 14A is a flowchart showing a fifth display position setting process executed by the controller, and FIG. 14B is a flowchart showing a second display process according to a fifth embodiment;

FIG. 15A is a flowchart showing a sixth display position setting process executed by the controller, and FIG. 15B is a flowchart showing a VRAM developing process according to a sixth embodiment;

FIG. 16 is a diagram showing an image data stored in a memory region of the VRAM in the sixth display position setting process;

FIG. 17 is a diagram showing right-left flip step of a character data;

FIG. 18A is a flowchart showing a seventh display position setting process executed by the controller, and FIG. 18B is a flowchart showing a first VRAM developing process for a character data according to a seventh embodiment;

FIG. 19 is a diagram showing a correspondence relationship among an image data of a character data storing database stored in the external memory, the memory region of the VRAM and the memory region of the display device according to the seventh embodiment;

FIG. 20 is a flowchart showing a second VRAM developing process for a character data according to an eighth embodiment; and

FIG. 21 is a diagram showing a correspondence relationship among an image data of a character data storing database stored in the external memory, the memory region of the VRAM and the memory region of the display device according to the eighth embodiment.

### DETAILED DESCRIPTION

### First Embodiment

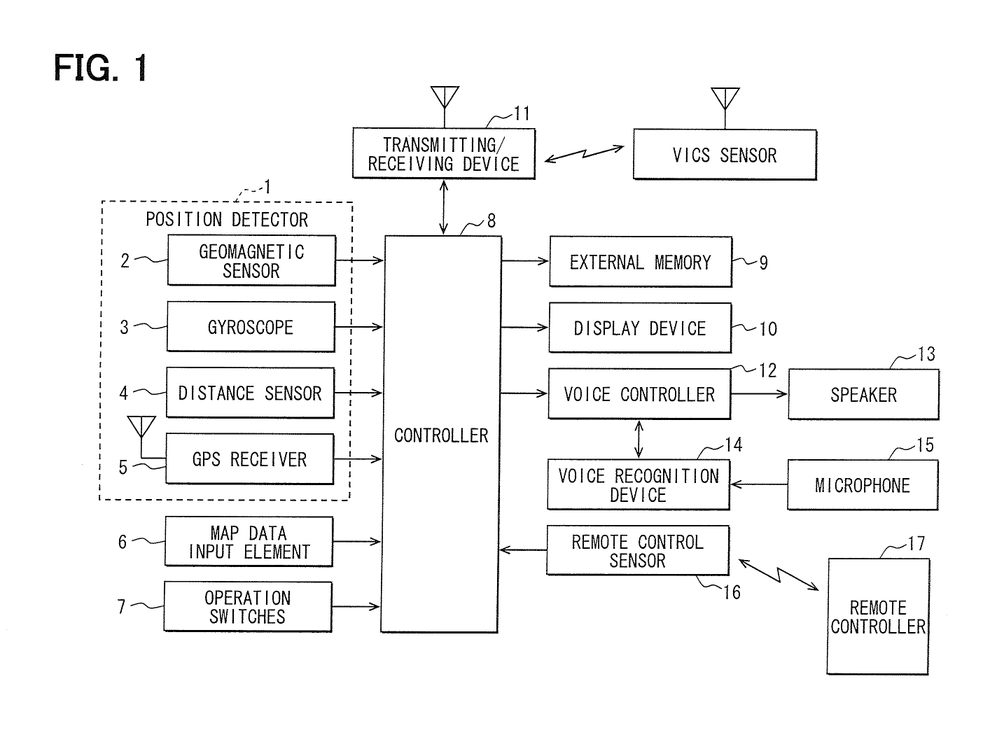

FIG. 1 shows, a whole construction of an in-vehicle navigation system according to a first embodiment. The system includes a position detector 1, a map data input element 6, operation switches 7, an external memory 9, a display device 10, a transmitting and receiving device 11, a voice controller 12, a speaker 13, a voice recognition device 14, a microphone 15, a remote control sensor 16, a remote controller 17 as a remote control terminal, and a controller 8. The controller 8 is coupled with the above elements.

The controller 8 is a conventional computer, and includes a CPU, a ROM, a RAM, a I/O device and a bus line, which couples the CPU, the ROM, the RAM and the I/O device. The controller 8 executes various processes such as a map scale change process, a menu screen selection process, a destination setting process, a route search executing process a route guidance starting process, a current position correction process a display screen change process and a sound volume control process based on various information input from the position detector 1 the map data input element 6, the operation switches 7, the external memory 9, the transmitting/receiving device 11, the voice controller 12, the remote control sensor 16 and the like. Further, the controller 8 outputs execution results to the external memory 9, the display device 10, the transmitting/receiving device 11, the voice controller 12 and the like. Specifically, in this navigation system, the controller 8 executes a first display position setting process for setting a display position of an image item on the screen of the display device 10.

The position detector 1 includes a GPS receiver 5 for a GPS (i.e., global positioning system). The GPS receiver 5 detects a current position of the vehicle based on information from the geomagnetic sensor 2, the gyroscope 3 and the distance sensor 4 and electric wave from a satellite. The information and the electric wave have different types of error, and therefore, the detector 1 utilizes the information and the electric wave with compensating with each other. In some cases, when it is required for the detector 1 to detect the position with not so high accuracy, the detector 1 may utilize only a part of information and the electric wave. Alternatively, the detector 1 may utilize information from a rotation sensor, an in-vehicle sensor for each wheel of the vehicle and the like.

The map data input element 6 includes a memory medium (not shown) attached to the element 6. The element 6 inputs various data including a map matching data, a map data and a land mark data and stored in the memory medium so that detection accuracy of the current position is improved. The memory medium is a CD-ROM, a DVD-ROM, a memory card, a HDD or the like.

The operation switches 7 are a touch switch and/or a mechanical switch, which are integrated into the display device 10. When a user operates the switches 7 various operation instructions are input into the controller 8. The operation instructions from the user are, for example, a map scale change instruction, a menu screen selection instruction, a destination setting instruction, a route search instruction, a route guidance starting instruction, a current position correction instruction, a display screen change instruction and a sound volume control instruction.

In the navigation system, the image and the text can be displayed in a language system, in which a character and a sentence are read and written from a right side to a left side, such as Arabic, Persian, and Hebrew, in addition to a language system, in which the character and the sentence are read and written from a left side to a right side, Japanese and English. When the user operates the operations witches 7, the language is set in the navigation system. The set language is stored in the external memory 9.

The remote controller 17 includes multiple switches (not shown). When the user operates the switch of the remote controller 17, various instruction signals are input into the controller 8 via the remote control sensor 16. The instructions corresponding to the signals are executed by the controller 8. The operation switches 7 and the remote controller 17 can be input the same instruction into the controller 8 for executing the same function. When the destination is set with using the remote controller 17 via the remote control sensor 16, or when the destination is set with using the operation switches 7, the controller 8 automatically searches an optimum route from the current position detected by the position detector 1 to the destination, and the controller 8 sets a guiding route. Then the controller 8 controls the display device 10 to display the guiding route on the screen. A method for setting the optimum route automatically is, for example, a Dijkstra method. The set route is displayed over the map image on the screen of the display device 10 together with a current position mark of the vehicle detected by the position detector 1. Thus, the optimum route and the current position mark are superimposed on the map image. Further, various information such as the current time and the traffic information may be displayed over the map image in addition to the current position mark and the route.

The external memory 9 is a rewritable memory device such as a HDD. The external memory 9 stores data, which is not deleted even when a power source turns off, and a large amount of data. Alternatively, the external memory 9 stores data, which is read out from the map data input element 6 and used very frequently. The external memory 9 may be a removable memory having a comparatively small memory amount. The external memory 9 also stores information about coordinates of an image item, dimensions of the image item, a type of the image item, and a content of the image item with regard to the image item to be displayed on the screen of the display device 10. The coordinates show a position of the item to be displayed.

The display device 10 displays the map image and the destination selection image for the navigation function. The device 10 can display in a full color. The device 10 includes, for example, a liquid crystal display panel or an organic EL display panel. When the user selects and sets the language system, the display position is determined according to the language system with respect to the image item such as an image and a text for providing the screen. Further, the display device 10 displays information shown as a character and a sentence in the selected language system.

The display device 10 includes a VRAM (i.e., video RAM, not shown) as a memory for a vide display image with respect to the display screen.

The transmitting/receiving device 11 receives traffic information, weather information, facility information, advertisement information and the like, which are presented by an external system such as an infrastructure of a VICS (vehicle information and communication system). Further, the transmitting/receiving device 11 transmits vehicle information and user information to the external system. The information received from the external system is processed in the controller 8. If necessary, information processed in the controller 8 is transmitted from the transmitting/receiving device 11.

The speaker 13 outputs a sound and/or a voice message such as guiding voice message, a screen operation explanation message and a voice recognition result based on the voice output signal from the voice controller 12. The microphone 15 receives voice from the user as an operator, and inputs the voice as an electric signal into the voice recognition device 14.

The voice recognition device 14 verifies the input voice of the user with vocabulary data in a recognition dictionary stored in the voice recognition device 14. The input voice of the user is input via the microphone 15. The vocabulary data of the recognition dictionary provides a comparison object pattern of the vocabulary. The voice recognition device 14 selects the vocabulary data having the highest degree of coincidence with the input voice, and then, outputs the selected vocabulary data as a recognition result to the voice controller 12. The voice controller 12 controls the voice recognition device 14, and outputs a message corresponding to the selected vocabulary data via the speaker 13 so that the user who inputs the voice via the microphone 15 confirms the message. This control method of the voice controller 12 is a talk back output control method. Further, the voice controller 12 inputs the recognition result into the controller 8. The controller 8 executes a certain process corresponding to the input voice of the user based on the information of the recognition result from the voice recognition device 14. Further, the controller 8 notifies the user of the route guiding voice information processed in the controller 8 with using the speaker 13 via the voice controller 12.

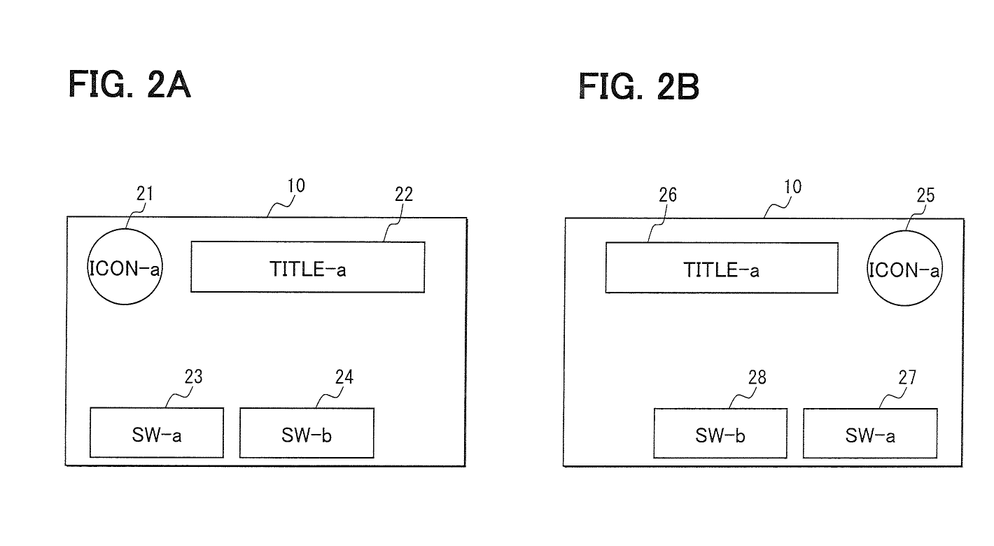

FIGS. 2A and 2B show screen images of the display device 10 when the user selects the language systems of English and Arabic respectively with using the navigation system.

The image items include an image such as an icon image as a bit map data and a text and a character as a text data. Here, when only a transparent frame for inputting the text is set, the transparent frame may not be displayed on the screen. However, even in this case, the transparent frame is also treated as the image item.

As shown in FIG. 2A, when the user selects English as the language system in the navigation device, the icon 21 is arranged on the left upper side, the title 22 is arranged on the right upper side, and the switch 23 is arranged on the left lower side, and the switch 24 is arranged on the right lower side. The switch 23 corresponds to, for example, the term “YES,” and the switch 24 corresponds to the term “NO” The switches 23, 24 are touch button on the screen of the display device. Since the language in English is read and written from the left side to the right side, the arrangement of the image items 21-24 is determined in view of the fact that a visual line of the user moves from the left side to the right side.

On the other hand, as shown in FIG. 2B, when the user selects Arabic as the language system in the navigation device, the icon 25 is arranged on the right upper side, the title 26 is arranged on the left upper side, and the switch 27 is arranged on the right lower side, and the switch 28 is arranged on the left lower side. The icon 25, the title 26, the switches 27, 28 have the same contents except for the position information as the icon 21, the title 22 and the switches 23, 24. Specifically, the switch 27 corresponding to the term “YES” is arranged on the right side, and the switch 28 corresponding to the term “NO” is arranged on the left side. Since the language in Arabic is read and written from the right side to the left side, the arrangement of the image items 25-28 is determined in view of the fact that a visual line of the user moves from the right side to the left side.

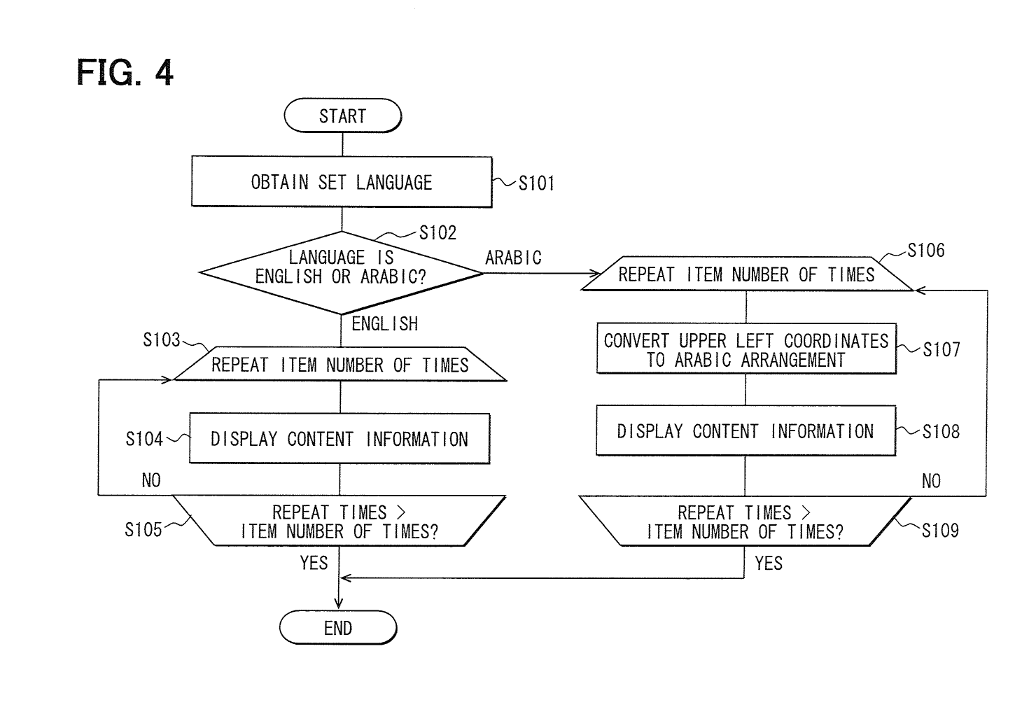

Thus the positions of the image items are reset when the language environment is switched from English to Arabic or from Arabic to English. This process is executed by the controller 8 in the first display position setting process shown in FIG. 4.

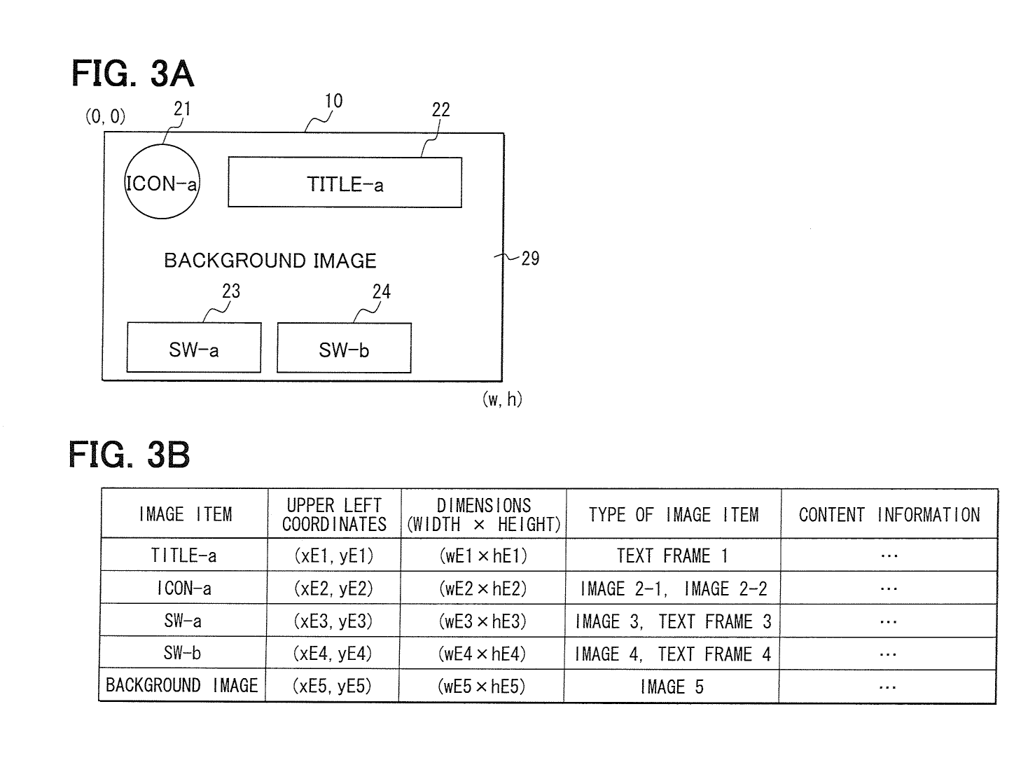

FIG. 3A shows a screen image of the display device 10. FIG. 3A corresponds to FIG. 2A. A corner of the upper left side of the screen image has the coordinates of (0, 0). A corner of the lower right side of the screen image has the coordinates of (w, h). Further, the background image 29 as the background of the screen image of the displayed device 10 is also the image item.

FIG. 3B shows a data format corresponding to the image item stored in the external memory 9. The items “TITLE-a;” “ICON-a,” “SW-a,” “SW-b” and “BACKGROUND IMAGE” are arranged in the vertical axis of the table in FIG. 3B, and correspond to the title 22, the icon 21, the switch 23, the switch 24 and the background image, respectively. The term “UPPER LEFT COORDINATES” in the horizontal axis in FIG. 3B represents X-Y coordinates on the two-dimensional plane, with which the upper left corner of each image item is arranged at a position of the screen image of the display device 10. For example, the upper left corner of the item “TITLE-a” has the coordinates of (xE1, yE1). The term “DIMENSIONS (WIDTH×HEIGHT)” in the horizontal axis represents the dimensions of each item as a width×height of the item. For example, the dimensions of the item “ICON-a” are (wE2×hE2). The term “TYPE OF IMAGE ITEM” in the horizontal axis represents attribution of the image item showing the form of data of the image item. In FIG. 3B, the image item has the attribution of both or one of the text frame and the image. For example, the item “SW-a” has the form “IMAGE 3” and “TEXT FRAME 3,” which are combined Each image item has content information such as text information and image information.

FIG. 4 is a flowchart showing the first display position setting process executed by the controller 8. The first display position setting process is executed when the display device 10 arranges and displays the image items. For example, when the user touches the touch switch so that all screen images are changed, i.e., all items are changed. Alternatively, when the user touches the touch switch so that a part of the screen images are changed, i.e., a part of items are changed. Thus, when the screen image is changed the first display position setting process is executed.

In step S101, the set language stored in the memory 9 is read out. Here the set language is, for example, English or Arabic.

In step S102, the controller 8 determines whether the set language is English or Arabic. When the set language is English it goes to step S103. When the set language is Arabic, it goes to step S106.

In the present embodiment, the language is English or Arabic. Alternatively, the user may select one of the language system such as Japanese, English and French that the user writes the sentence from the left side to the right side and the language system such as Arabic, Persian, and Hebrew that the user writes the sentence from the right side to the left side.

In steps S103 to S105, step S104 is repeatedly executed with respect to the image items to be displayed. Specifically, step S104 is repeated the item number of times. In step S105, when the repeat times are larger than the item number of times, the first display position setting process ends. When the repeat times are equal to or smaller than the item number of times, it goes to step S103.

In step S104, the content information of each image item is displayed such that the upper left coordinates of the image item stored in the memory 9 is a starting point of the display position, and the display frame of the item has certain dimensions. In this case, since the language system is English, the upper left coordinates are not converted, but the item is arranged with the original upper left coordinates.

On the other hand in steps S106 to S109, steps S107 and S108 are repeatedly executed with respect to the image items to be displayed. Specifically, steps S107 and S108 are repeated the item number of times. In step S109, when the repeat times are larger than the item number of times, the first display position setting process ends. When the repeat times are equal to or smaller than the item number of times, it goes to step S106.

In step S107, the upper left coordinates of each item is read out from the memory 9. Then each image item is arranged according to a case where the setting language is Arabic. Specifically, the X coordinate of each item is re-calculated, i.e., converted to Arabic arrangement coordinate so that the English arrangement is converted to be bilaterally symmetric. Thus, the English arrangement and the Arabic arrangement have symmetry. More specifically, for example, the item “TITLE-a” has the X coordinate of the upper left coordinates in the English arrangement, i.e., in the original arrangement, which is defined as xE1. The X coordinate of the upper left coordinates in the Arabic arrangement is defined as xA1. The X coordinate of xA1 is calculated as follows.

xA1=w−xE1−wE1 (F1)

Here, the x coordinate of xE1 provides the upper left coordinates in the language system such as English that the user writes the sentence from the left side to the right side. Here, a horizontal width of the screen image is defined as w, and the horizontal width of each item is defined as wE1. In the language system such as Arabic that the user writes the sentence from the right side to the left side, the upper left X coordinate of xE1 is subtracted from the width of w of the screen image, and further, the width of wE1 of each item is subtracted from the width of w of the screen image. Specifically, since the item itself in the English arrangement is not reversed in a mirror symmetric manner, it is required to shift the upper left X coordinate of xA1 to the left side by the width of the item itself. When the setting language is Arabic, each item is arranged at a right-left reversal position of the English arrangement item. Thus, the position information about the upper left X coordinate of xA1 in the Arabic arrangement is obtained by re-calculating the upper left X coordinate of xA1 in the English arrangement.

Thus, the above calculation is executed at each image item.

In step S108, the content information of each image item is displayed such that the upper left coordinates of the image item calculated in step S107 is a starting point of the display position, and the display frame of the item has certain dimensions.

Thus in the in-vehicle navigation system according to the first embodiment the language system used for the interface environmental conditions is obtained in step S101. Then it is determined in step S102 whether the selected language system is the language system such as English that the sentence is written and read from the left side to the right side or the language system such as Arabic that the sentence is written and read from the right side to the left side. In case of the Arabic arrangement, the horizontal coordinate, i.e., the X coordinate of each item is re-calculated in step S107. Then in step S108, each item is arranged in the Arabic arrangement. Thus, even when the language system is Arabic, each item is arranged at an appropriate position without increasing the area of use of the memory 9.

In the present embodiment, step S101 executed by the controller 8 corresponds to an obtaining element, step S107 executed by the controller 8 corresponds to a reading element, step S107 executed by the controller 8 corresponds to a setting element, and step S108 executed by the controller 8 corresponds to a displaying element.

### Second Embodiment

A navigation system according to a second embodiment will be explained as follows.

In this embodiment, the external memory 9 stores information whether a vehicle is a right-side steering wheel vehicle or a left-side steering wheel vehicle. Specifically, the memory 9 stores steering wheel information of the vehicle, on which the navigation system is mounted. The steering wheel information is preliminary stored in the memory 9 at a time when the navigation system is mounted on the vehicle. Thus, the steering wheel position information whether the vehicle is the right-side steering wheel vehicle or the left-side steering wheel vehicle is stored in a memory device of the vehicle (not shown). When the navigation system is mounted on the vehicle, the steering wheel position information together with other information of the vehicle is automatically stored in the memory 9. Here when the navigation system is mounted on the vehicle, the user may operate the memory 9 to store the steering wheel position information.

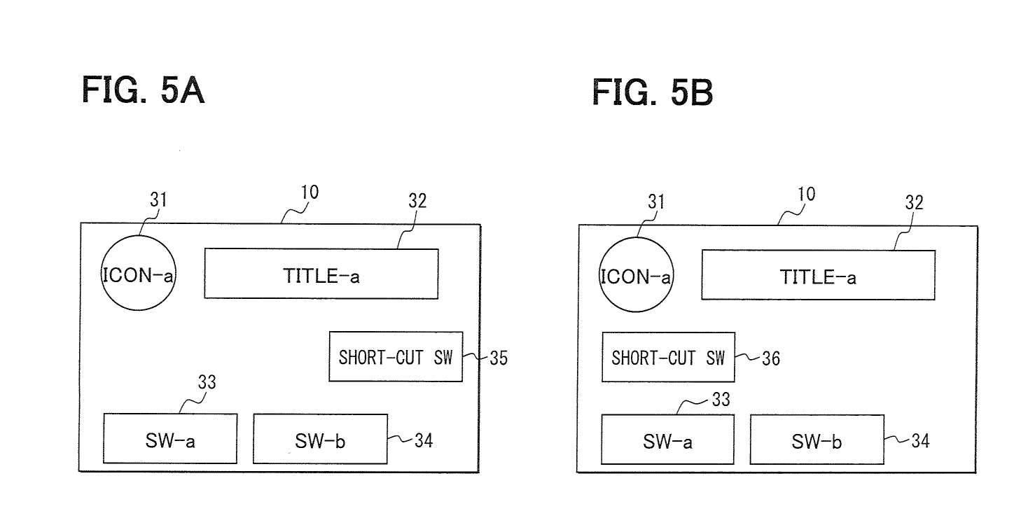

FIG. 5A shows a screen image of the display device 10 when the vehicle is the right-side steering wheel vehicle. FIG. 5B shows a screen image of the display device 10 when the vehicle is the left-side steering wheel vehicle.

As shown in FIG. 5A, when the vehicle is the right-side steering wheel vehicle, the icon 31 is arranged on the upper left side of the screen image, the title 32 is arranged on the upper right side of the screen image, the switch 33 is arranged on the lower left side, and the switch 34 is arranged on the lower right side of the screen image. The image items 31-34 correspond to the image items 21-24, respectively. However, each item 31-34 has information about a switching flag.

A switch 35 represents the term “SHORT-CUT SW” The switch 35 is a short-cut touch switch for executing a frequently used process among various processes in the navigation system. The switch 35 is arranged on the middle right side of the screen image when the user, i.e., a driver of the vehicle rides on the right-side steering wheel vehicle. In this case, the user can easily operate the switch 35 with his left hand.

As shown in FIG. 5B, when the vehicle is the left-side steering wheel vehicle, the positions of the items 31-34 are the same as a case where the vehicle is the right-side steering wheel vehicle. The switch 36 representing the term “SHORT-CUT SW” is arranged on the middle left side of the screen image. Specifically, the switch 36 is arranged on the middle left side of the screen image when the user, i.e., the driver of the vehicle rides on the left-side steering wheel vehicle. In this case, the user can easily operate the switch 36 with his right hand. The switch 36 provides the same image item as the switch 35, but the position information of the switch 36 is different from the position information of the switch 35.

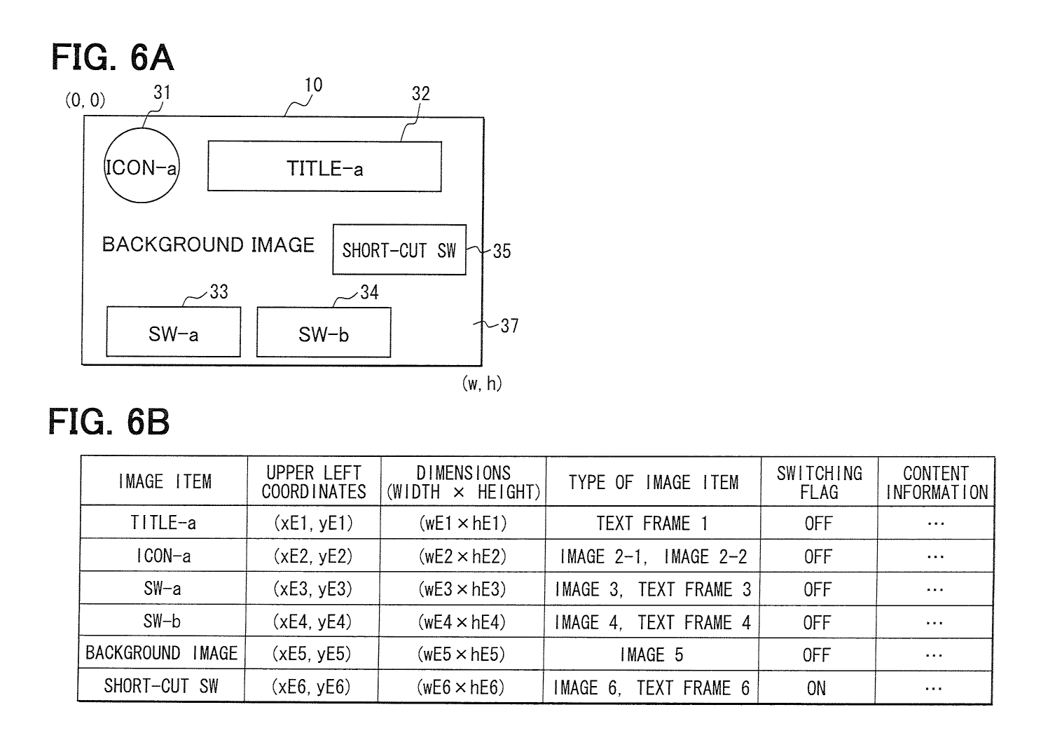

FIG. 6A shows a screen image of the display device 10 and corresponds to the screen image of FIG. 5A. The screen image of FIG. 6A is substantially the same as the screen image of FIG. 6A except for the switch 35. Further, the background image 37 as the background of the screen image of the display device 10 is also the image item.

FIG. 6B is a data format corresponding to the image items in FIG. 6A stored in the external memory 9. The items “TITLE-a,” “ICON-a,” “SW-a,” “SW-b,” “BACKGROUND IMAGE” and “SHORT-CUT SW” are arranged in the vertical axis of the table in FIG. 6B, and correspond to the title 32, the icon 31 the switch 33, the switch 34, the background image 37 and the switch 35, respectively. The items in FIG. 6B are substantially the same as the items in FIG. 3B except for the switch 35. The terms “UPPER LEFT COORDINATES,” “DIMENSIONS (WIDTH×HEIGHT),” “TYPE OF IMAGE ITEM,” “SWITCHING FLAG,” and “CONTENT INFORMATION” are substantially the same as the items in FIG. 3B except for the term “SWITCHING FLAG.”

The switch 35 representing the term “SHORT-CUT SW” is the touch button for executing the frequently used process for the user.

The switching flag provides flag information showing the determination under an environmental conditions whether the arrangement of the image items is reset. In this case the controller 8 determines whether the arrangement of items is changed according to the condition such that the vehicle is the right-side steering wheel vehicle or the left-side steering wheel vehicle. When the switching flag is “ON,” an image item is re-arranged. When the switching flag is “OFF,” the image item is not re-arranged.

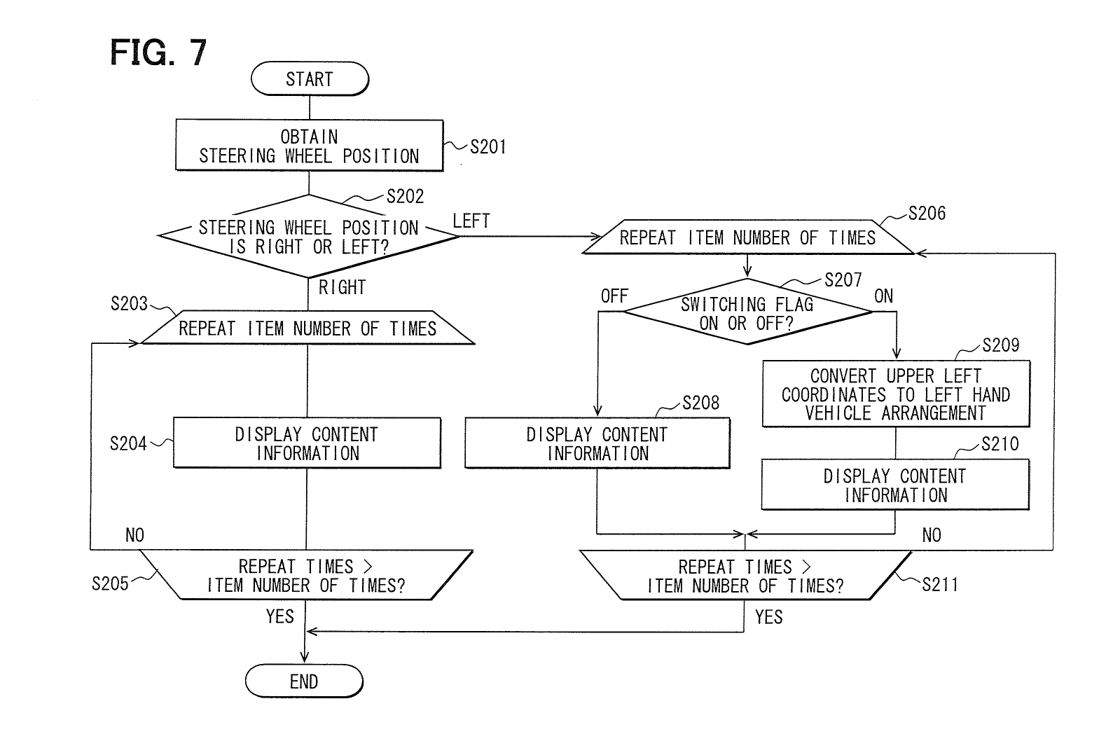

FIG. 7 shows a second display position setting process executed by the controller 8 according to the second embodiment. The second display position setting process is executed at the same timing of the first display position setting process.

In step S201, the steering wheel position information is read out from the external memory 9, the information showing that the vehicle is the right-side steering wheel vehicle or the left-side steering wheel vehicle.

In step S202, the controller 8 determines whether the steering wheel position of the vehicle is the right side or the left side. When the steering wheel position of the vehicle is the right side, it goes to step S203. When the steering wheel position of the vehicle is the left side, it goes to step S206.

Steps S203 to S205 are the same as steps S103 to S105 in the first display position setting process. In this case, since the upper left coordinates stored in the memory 9 corresponds to the right side steering wheel vehicle, it is not necessary to convert, i.e., re-calculate the upper left coordinates of each item.

In steps S206 to S211, steps S207 to S210 are repeatedly executed with respect to the image items to be displayed. Specifically, steps S207 to S210 are repeated the item number of times. After that, the second display position setting process ends.

In step S207, information about each image item is read out from the memory 9 so that the controller 8 determines whether the switching flag of each item is “ON” or “OFF.” When the switching flag of each item is “OFF,” i.e., the determination in step S207 is “OFF,” it goes to step S208. When the switching flag of each item is “ON,” i.e. the determination in step S207 is “OFN,” it goes to step S209.

Step S208 is the same as step S204 corresponding to step S104 in the first display position setting process. Even in a case where the vehicle is the left side steering wheel vehicle, it is not necessary to convert, i.e., re-calculate the upper left coordinates of the item when the switching flag of the item is “OFF.”

In step S209, the upper left coordinates of the item stored in the memory 9 is converted to i.e., re-calculated for the left side steering wheel vehicle. Specifically, for example, the item “SHORT-CUT SW” has the X coordinate of the upper left coordinates in the right hand vehicle arrangement, i.e., in the original arrangement, which is defined as xE6. The X coordinate of the upper left coordinates in the left hand vehicle arrangement is defined as xA6. The X coordinate of xA6 is calculated as follows.

xA6=w−xE6−wE6 (F2)

Here, the x coordinate of xE6 provides the upper left coordinates in the right hand vehicle. Here, the horizontal width of the screen image is defined as w, and the horizontal width of each item is defined as wE6. In the left hand vehicle arrangement, the upper left X coordinate of xE6 is subtracted from the width of w of the screen image, and further, the width of wE6 of each item is subtracted from the width of w of the screen image. In this calculation, the position information of each item is reset so that the item is displayed for the left hand vehicle in such a manner that the item in the left hand vehicle is arranged at a right-left reversal position of the right hand vehicle arrangement item.

Thus, the above calculation is executed at each image item.

In step S210, the content information of each image item is displayed such that the upper left coordinates of the image item calculated in step S209 is a starting point of the display position, and the display frame of the item has certain dimensions.

Thus, in the in-vehicle navigation system according to the second embodiment, even when the vehicle is the left hand vehicle, the switch 36 to be displayed as the image item corresponding to the term “SHORT-CUT SW” is arranged on the left side of the screen image of the display device 10. Thus, operability of the user is improved.

Further, each item includes the switching flag for showing whether the arrangement of the item is reset or not. Only when the switching flag is “ON,” the arrangement of the item is reset in steps S207, S209 and S210. Accordingly, even when the vehicle is the left side steering wheel vehicle the position information of a certain image item is not reset when it is not necessary to reset the position of the certain image item. Thus, the image item is appropriately arranged on the screen image according to the environmental conditions of the interface.

In the present embodiment, step S201 executed by the controller 8 corresponds to an obtaining element, step S207 executed by the controller 8 corresponds to a reading element, step S209 executed by the controller 8 corresponds to a setting element, and step S210 executed by the controller 8 corresponds to a displaying element.

### Third Embodiment

Next, a third embodiment will be explained as follows.

In the third embodiment, the display device 10 includes an optical sensor (not shown) for detecting light having intensity equal to or larger than a predetermined threshold intensity. When the panel of the display device 10 is exposed to the sunlight, a portion of the screen image is exposed to the sunlight, and other portion of the screen image is shaded. The optical sensor specifies a position on the screen image, at which it is difficult for the user to see because of reflection of the sunlight. Here, the position is defined as a sunlight reflection position. Since the panel of the display device 10 is horizontally long, even if it is difficult for the user to see the left side of the screen of the display device 10 because of the reflection of the sunlight, the right side of the screen may be easily viewable.

Specifically, two optical sensors are mounted on the right and left sides of the panel of the display, device 10. Each optical sensor detects a part of the screen of the display device 10, on which the sunlight having intensity equal to or larger than a predetermined threshold intensity shines, and the user does not easily see the part of the screen of the display device 10 since the sunlight reflects on the part of the screen. Thus, the sensor detects the part of the screen as the sunlight reflection position. More specifically, with using two optical sensors mounted on the right and left sides of the display device 10, the sensors determine one of situations that the sunlight reflection position is disposed only on the right side of the display device 10, the sunlight reflection position is disposed only on the left side of the display device 10, the sunlight reflection position is disposed on both of the right and left sides of the display device 10, and no sunlight reflection position is disposed on the right and left sides of the display device 10. The sunlight reflection position information on the screen image obtained by the optical sensors is transmitted to the CPU of the controller 8.

Although the display device 10 includes the optical sensors, the display device 10 may include other elements for detecting light. Further, an element for detecting light may be mounted on a body other than the display device 10.

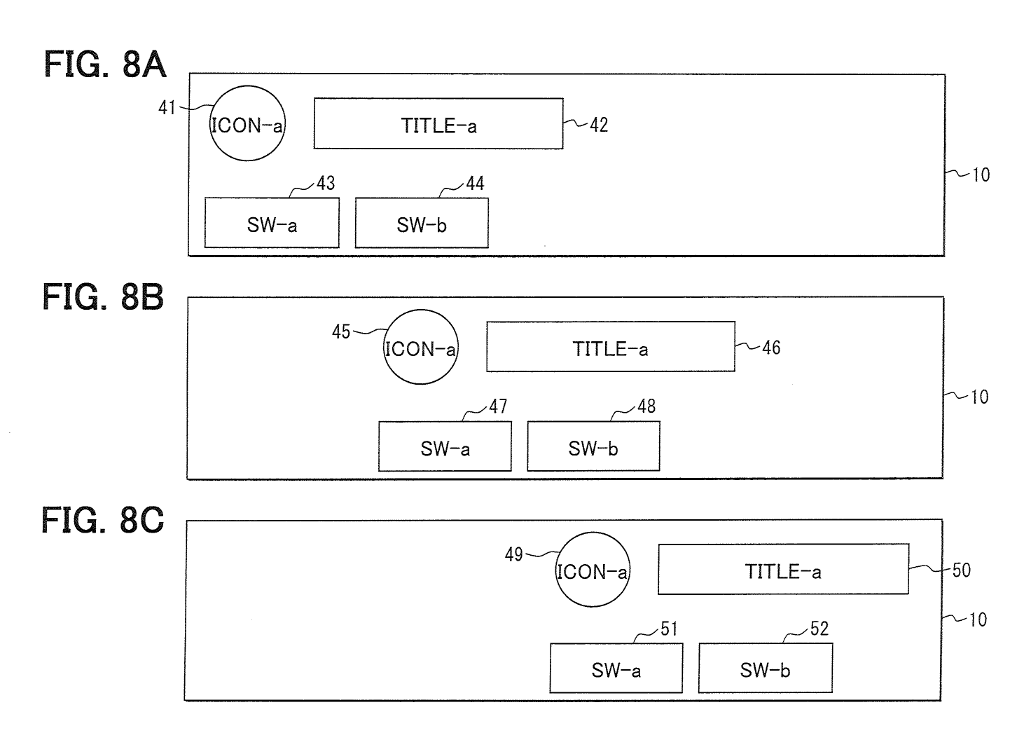

FIG. 8A shows a screen image when the sunlight reflection position is disposed on the right side of the screen. FIG. 8B shows a screen image when the sunlight reflection position is disposed on a whole of the screen or when no sunlight reflection position is disposed on the screen. FIG. 8C shows a screen image when the sunlight reflection position is disposed on the left side of the screen.

As shown in FIG. 8A, when the sunlight reflection position is disposed on the right side of the screen, the icon 41, the title 42 and the switches 43, 44 are disposed on the left side of the screen image. The items 41-44 correspond to the items 21-24, respectively, although the X coordinate of each item 41-44 is different from the corresponding item 21-24.

As shown in FIG. 8B, when the sunlight reflection position is disposed on a whole of the screen or when no sunlight reflection position is disposed on the screen, the icon 45, the title 46 and the switches 47, 48 are disposed on a center of the screen image, which is a normal position. Here, the memory 9 stores the position information of the upper left coordinates of each item that provides to display each item on the lefty side of the screen when the sunlight reflection position is disposed on the right side of the screen. The icon 45, the title 46 and the switches 47, 48 in FIG. 8B correspond to the icon 41, the title 42 and the switches 43, 44, respectively, but only the position information of the item 45-48 is different from the corresponding item 41-44.

As shown in FIG. 8C, when the sunlight reflection position is disposed on the left side of the screen, the icon 49, the title 50 and the switches 51, 52 are disposed on the right side of the screen. The icon 49, the title 50 and the switches 51, 52 in FIG. 8C correspond to the icon 41, the title 42 and the switches 43, 44, respectively, but only the position information of the item 49-52 is different from the corresponding item 41-44.

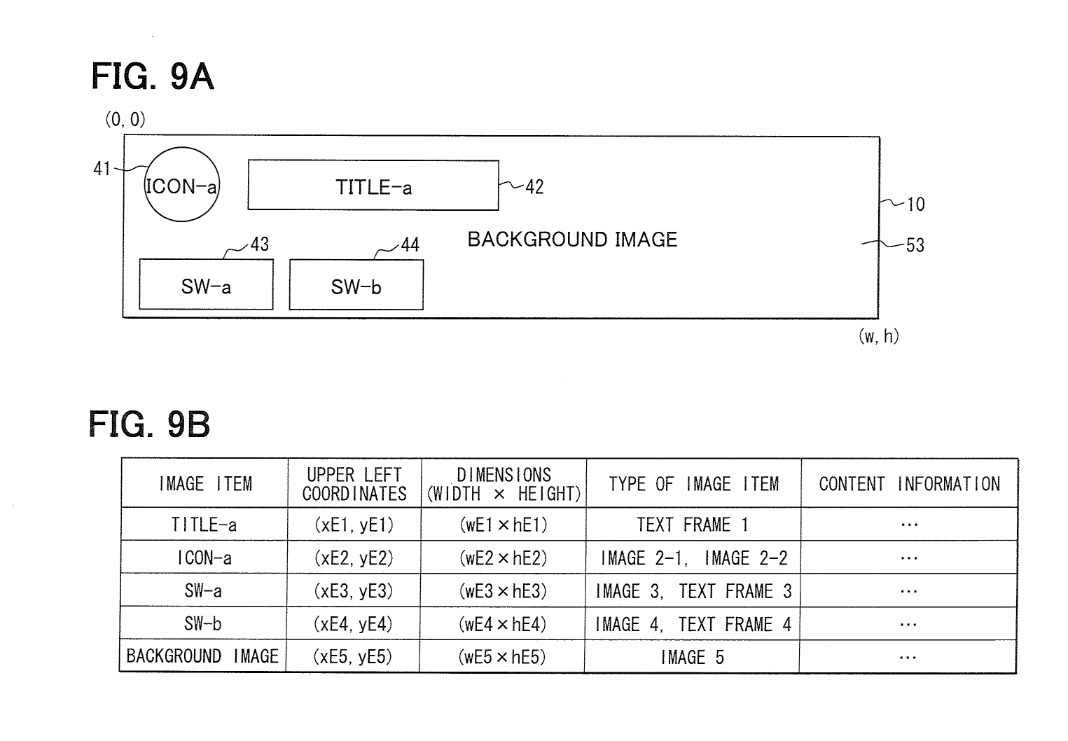

FIG. 9A shows a screen image of the display device 10. The image in FIG. 9A corresponds to the image in FIG. 8A. The background image 53 as the background of the screen image in the display device 10 is also an image item.

FIG. 9B is a data format corresponding to the image items in FIG. 9A stored in the external memory 9. The items “TITLE-a,” “ICON-a,” “SW-a,” “SW-b” and “BACKGROUND IMAGE” are arranged in the vertical axis of the table in FIG. 9B, and correspond to the title 42, the icon 41, the switch 43, the switch 44, and the background image 37, respectively. The terms “UPPER LEFT COORDINATES,” “DIMENSIONS (WIDTH×HEIGHT),” “TYPE OF IMAGE ITEM,” and “CONTENT INFORMATION” are substantially the same as the items in FIG. 3B.

In the present embodiment, the X coordinate of the upper left coordinates of each item stored in the memory 9 corresponds to the position of the item disposed on the left side of the screen when the sunlight reflection position is disposed on the right side of the screen.

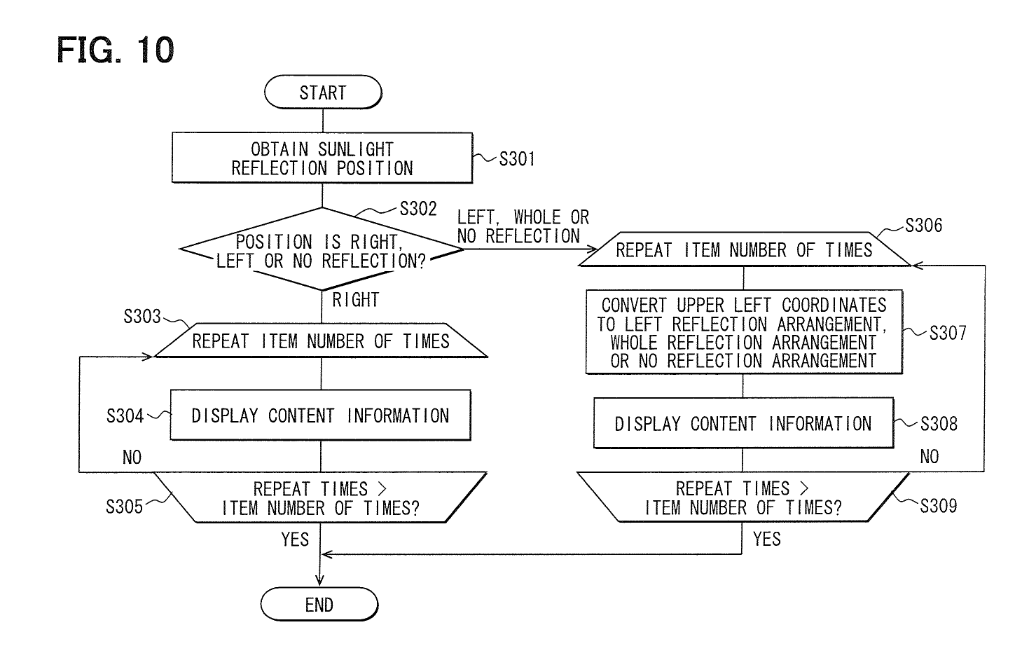

FIG. 10 shows a third display position setting process executed by the controller 8. The third display position setting process is executed at the same timing of the first display position setting process.

In step S301, the controller 8 obtains the sunlight reflection position information that shows whether the sunlight reflection position is disposed on the left side of the screen image on the right side of the screen image, on a whole of the screen image, or no sunlight reflection position is disposed on the screen.

In step S302, the controller 8 determines whether the sunlight reflection position is disposed on the left side of the screen image, on the right side of the screen image, on a whole of the screen image, or no sunlight reflection position is disposed on the screen. When the sunlight reflection position is disposed on the right side of the screen image, i.e., when the determination in step S302 is “RIGHT,” it goes to step S303. When the sunlight reflection position is disposed on the left side of the screen image on a whole of the screen image, or no sunlight reflection position is disposed on the screen, i.e., when the determination in step S302 is “LEFT,” “NO,” or “WHOLE,” it goes to step S306.

Steps S303 to S305 are the same as steps S103 to S105 in the first display position setting process. In this case, since the upper left coordinates stored in the memory 9 corresponds a case where the sunlight reflection position is disposed on the right side of the screen, it is not necessary to convert, i.e., re-calculate the upper left coordinates of each item.

In steps S306 to S309, steps S307 to S308 are repeatedly executed with respect to the image items to be displayed. Specifically, steps S307 to S308 are repeated the item number of times. After that, the third display position setting process ends.

In step S307, the controller 8 re-calculates the upper left coordinates of each item stored in the memory 9 according to a case where the sunlight reflection position is disposed on the left side of the screen, a case where the sunlight reflection position is disposed on a whole of the screen, or a case where no sunlight reflection position is disposed on the screen. Specifically, the X coordinate of the upper left coordinates in the term “TITLE-a” is calculated as follows.

When the sunlight reflection position is disposed on the left side of the screen, the X coordinate of the upper left coordinates in the left side reflection position arrangement is defined as xA1.

The X coordinate of xA1 is calculated by the following equation F3.

xA1=xE1+Wleft (F3)

Here, the X coordinate of the upper left coordinates in the right side reflection position arrangement is defined as xE1. Here, the term “Wleft” is a parameter for displacing the upper left coordinates along with the X axis so as to arrange the item on the right side of the screen.

When the sunlight reflection position is disposed on the whole of the screen, or when no sunlight reflection position is disposed on the screen, the X coordinate of xA1 is calculated by the following equation F4.

xA1=xE1+Wmiddle (F4)

Here, the term “Wmiddle” is a parameter for displacing the upper left coordinates along with the X axis so as to arrange the item on the center of the screen.

Thus, the X coordinate of each item is re-calculated similarly.

In the navigation system according to the third embodiment, when the screen of the display device 10 is exposed to the sunlight, the sunlight is reflected on the screen and/or the screen is shaded. In this case, in steps S302 to S309, the display device 10 displays the content information of each item, which is arranged to avoid the sunlight reflection position since it is difficult for the user to see the item. The user clearly recognizes the contents of the screen image on the display device 10.

In the third embodiment, step S301 executed by the controller 8 corresponds to an obtaining element, step S307 executed by the controller 8 corresponds to a reading element, step S307 executed by the controller 8 corresponds to a setting element, and step S2308 executed by the controller 8 corresponds to a displaying element.

### Fourth Embodiment

In the first to third embodiments the arrangement of each item is determined by the environmental conditions such as the language system. In the fourth to sixth embodiments, the screen image other than characters and sentences is right-left reversed according to the environmental conditions such as the language system so that the arrangement of each item is set. When the image item represents characters and/or sentences and the image item is mirror-reversed, it is very difficult to read the characters and/or the sentences for the user. Thus, when the characters and the sentences are reversed the user cannot read the characters and the sentences. In the fourth to sixth embodiments, the image item such as a figure and a drawing other than the characters and the sentences provides the screen image.

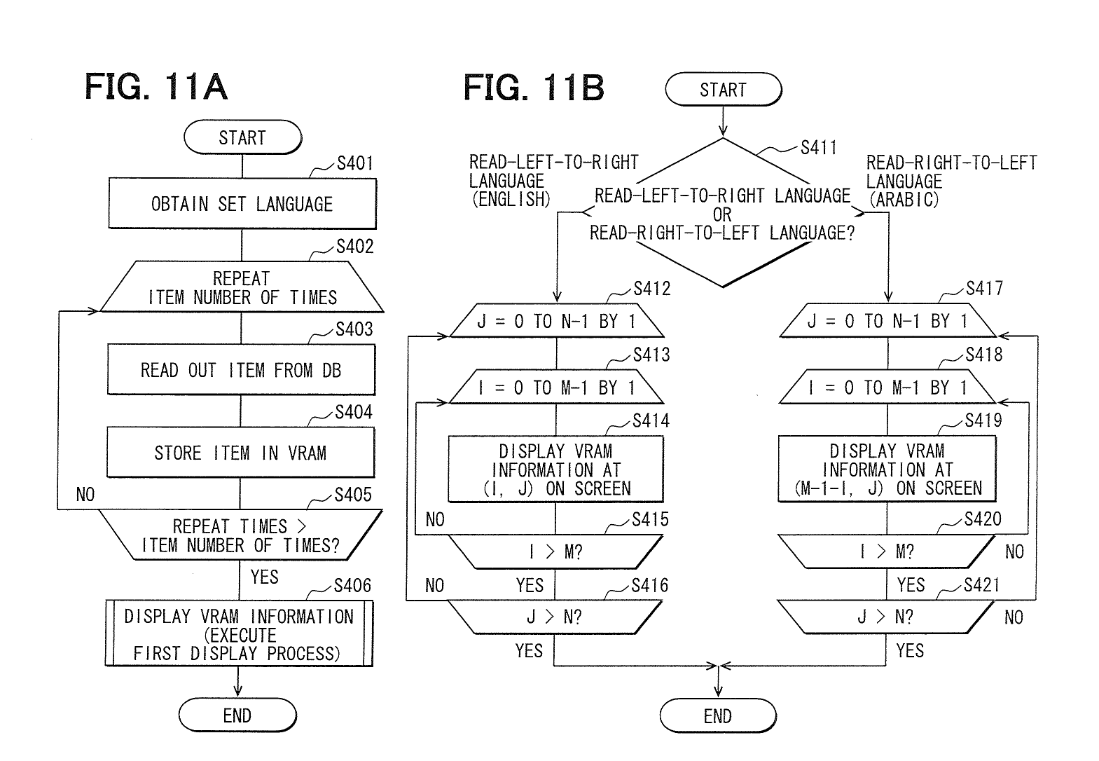

FIG. 11A shows a flowchart of a fourth display position setting process executed by the controller 8, and FIG. 11b shows a flowchart of a first display process for displaying information of the VRAM on the display device 10 corresponding to step S406 in FIG. 11A. The fourth display position setting process is executed at the same timing of the first display position setting process.

Step S401 corresponds to step S101 in the first display position setting process. In step S401, the controller 8 obtains the language system used for the environmental condition of the interface.

Next, in steps S402 to S405, steps S403 to S404 are repeatedly executed with respect to the image items to be displayed. Specifically, steps S403 to S404 are repeated the item number of times. After that, it goes to step S406.

In step S403 the image item is read out from the memory 9. In step S404, the image item in step S403 is stored in the memory region in the VRAM of the display device 10.

The image item stored in the VRAM of the displayed device 10 in steps S402 to S405 is processed in step S406, and then, the fourth display position setting process ends. In step S406 the first display process is executed so that the information, i.e., the image item stored in the VRAM is displayed on the display device 10. FIG. 11B shows the first display process.

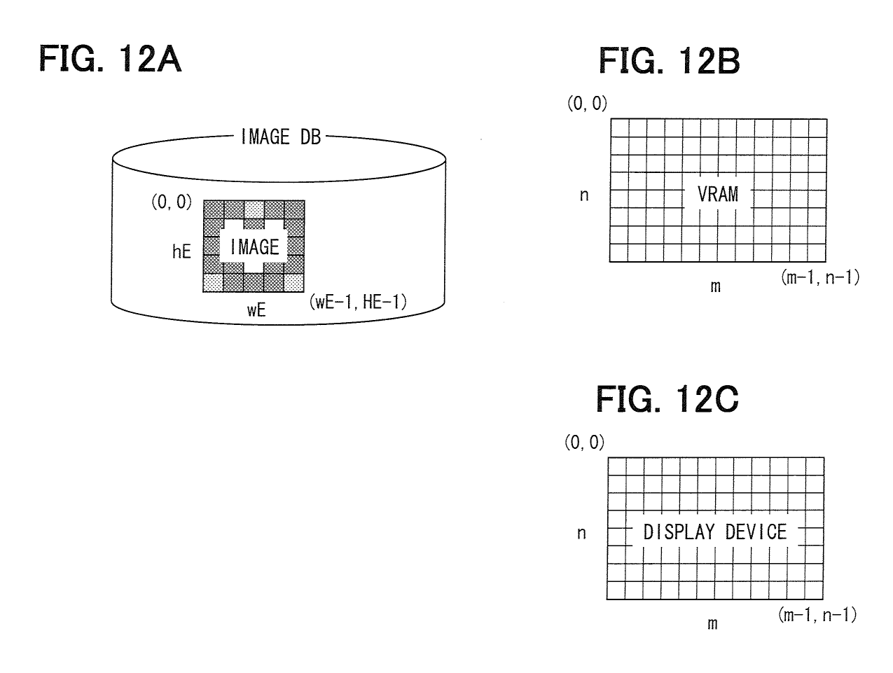

FIGS. 12A to 12C show a relationship among the image data in the image database of the memory 9, data in the memory region of the VRAM and data on the display screen of the display device 10. As shown in FIG. 12A, when the image data has a width wE in the X direction and a height hE in the Y direction, and the upper left coordinates are defined as (0, 0), the lower right coordinates are (wE−1, hE−1). As shown in FIG. 12B, when the memory region of the VRAM has a width M in the X direction and a height N in the Y direction, and the upper left coordinates are defined as (0, 0), the lower right coordinates are (M−1, N−1) As shown in FIG. 12C, when the display screen of the display device 10 has a width M in the X direction and a height N in the Y direction, and the upper left coordinates are defined as (0, 0), the lower right coordinates are (M−1, N−1) which correspond to the memory region of the VRAM.

FIG. 11B shows the image data having the width M in the X direction and the height N in the Y direction and stored in the memory region of the VRAM, which is displayed on the display screen of the display device 10 in the first display process.

In step S411, the controller 8 determines whether the set language obtained in step S401 is the read-left-to-right language such as English or the read-right-to-left language such as Arabic. When the set language is the read-left-to-right language, i.e., when the determination of step S411 is “READ-LEFT-TO-RIGHT LANGUAGE,” it goes to step S412. When the set language is the read-right-to-left language, i.e., when the determination of step S411 is “READ RIGHT-TO-LEFT LANGUAGE,” it goes to step S417.

Steps S412 to S416 are a process of each image item to be displayed in a case where the set language is the read-left-to-right language such as English. Steps S413 to S415 are repeatedly executed by N-th times in each image data. Specifically, in step S412, index J starts from zero and ends to N−1 by adding one so that the index 3 runs from 0 to N−1 by adding one. Thus, the Y coordinate runs from 0 to N−1 and is added to one at every repeat time.

Further, in steps S413 to S415 step S414 is repeatedly executed by M-th times in the same image data. Specifically, in step S413 index I starts from zero and ends to M−1 by adding one so that the index I runs from 0 to M−1 by adding one. Thus, the X coordinate runs from 0 to M−1 and is added to one at every repeat time.

In step S414, the X-Y coordinates (I, J) in the memory region of the VRAM with respect each image item is directly used for displaying the item on the display screen of the display device 10. In this case, since the language system is the normal read-left-to-right language so that it is not necessary to reverse the item the item is displayed at the original coordinates.

Steps S417 to S421 are a process of each image item to be displayed in a case where the set language is the read-right-to-left language such as Arabic. Steps S418 to S420 are repeatedly executed by N-th times. Specifically, in step S418, the index 3 starts from zero and ends to N−1 by adding one so that the index 3 runs from 0 to N−1 by adding one. Thus, the Y coordinate runs from 0 to N−1, and is added to one at every repeat time. Further, in steps S418 to S420, step S419 is repeatedly executed by M-th times. Specifically, in step S418, index I starts from zero and ends to M−1 by adding one so that the index I runs from 0 to M−1 by adding one. Thus, the X coordinate runs from 0 to M−1, and is added to one at every repeat time. Step S419 in the case where the set language is the read-right-to-left language corresponds to step S414 in the case where the set language is the read-left-to-right language.

Step S419 does not provide to directly display each item at the X-Y coordinates of (I, J) stored in the memory region of the VRAM in the display device 10, but executes a process for displaying the item at the X-Y coordinates of (M−1−I, J) of the display screen so that the item is mirror-reversed. In this case, since the language system is the read-right-to-left language so that it is necessary to reverse the item, the item is mirror-reversed and displayed at the converted coordinates.

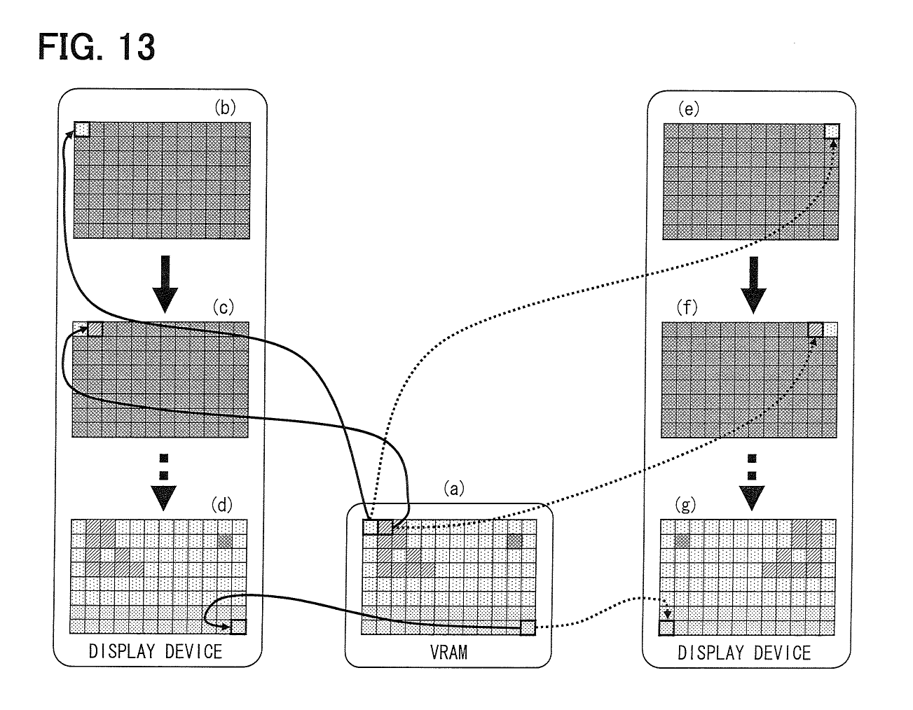

FIG. 13 shows a relationship among the image data, a corresponding data in the VRAM of the display device 10 and the corresponding data on the display screen of the display device 10. (a) in FIG. 13 shows the image data stored in the memory region of the VRAM. (b) to (d) in FIG. 13 show the display screen of the display device 10 when the set language is the read-left-to-right language. (e) to (g) in FIG. 13 show the display screen of the display device 10 when the set language is the read-right-to-left language.

As shown in (b) of FIG. 13, the coordinates disposed on the upper left side of the data in the VRAM in (a) of FIG. 13 is directly displayed on the display screen of the display device 10 at the coordinates on the upper left side. As shown in (c) of FIG. 13, pixels of the data in the VRAM in (a) of FIG. 13 are displayed in an order from left to right on the display screen of the display device 10 at the same coordinates. Finally, as shown in (d) of FIG. 13, the image data in (a) of FIG. 13 is displayed directly on the display screen of the display device 10.

On the other hand, as shown in (e) of FIG. 13, when the set language is the read-right-to-left language, the coordinates disposed on the upper left side of the data in the VRAM in (a) of FIG. 13 is displayed on the display screen of the display device 10 at the coordinates of the upper right side of the display screen of the display device 10. As shown in (f) of FIG. 13, pixels of the data in the VRAM in (a) of FIG. 13 are displayed in an order from right to left on the display screen of the display device 10. Finally, as shown in (g) of FIG. 13, the image data in (a) of FIG. 13 is displayed to be mirror-reversed on the display screen of the display device 10.

In the navigation system according to the fourth embodiment, when the set language is the read-right-to-left language such as Arabic, the image data stored in the memory region of the VRAM is mirror-reversed and displayed on the display device 10. Thus, it is not necessary to add a calculation process for calculating new coordinates. The process in the navigation system is rapidly performed.

In the fourth embodiment step S403 executed by the controller 8 corresponds to an image obtaining element, step S401 executed by the controller 8 corresponds to a display direction information obtaining element, and steps S417 to S421 executed by the controller 8 corresponds to a display control element.

### Fifth Embodiment

A fifth embodiment will be explained.

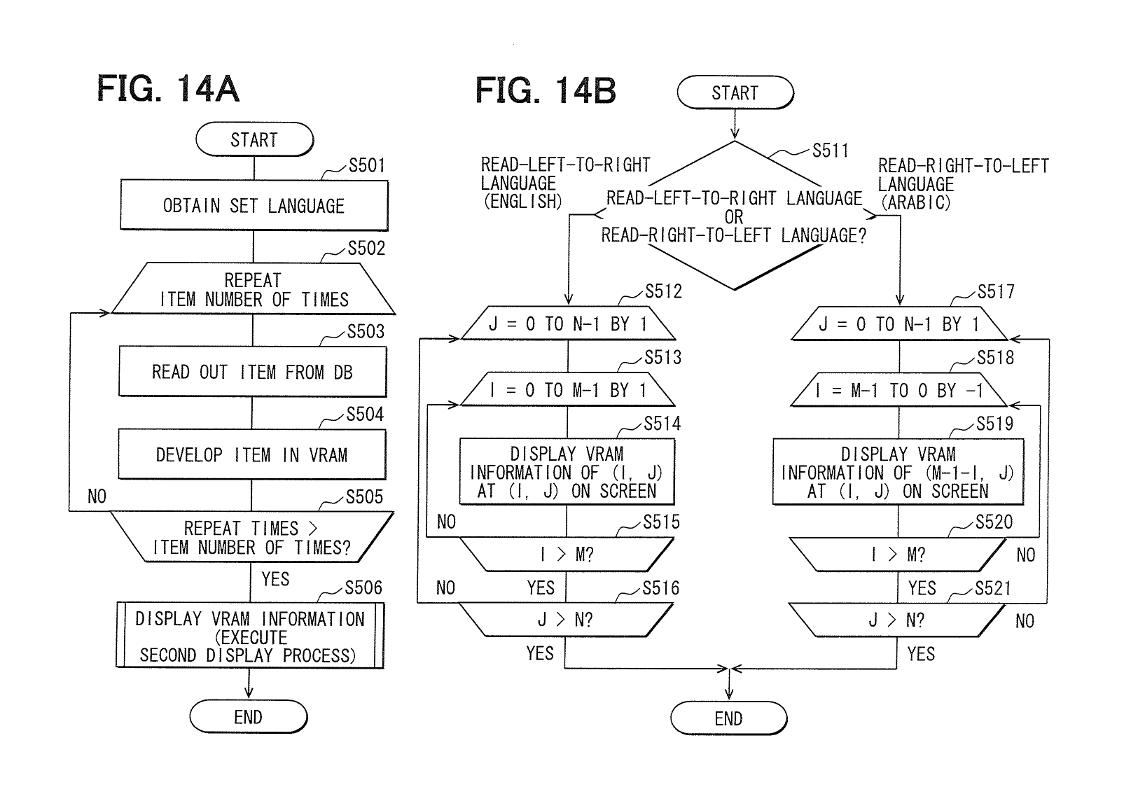

FIG. 14A shows a flowchart of a fifth display position setting process executed by the controller 8 according to the fifth embodiment. Steps S501 to S506 in FIG. 14A correspond to steps S401 to S406 in FIG. 11A. In step S406 of the fourth display position setting process, the first display process in FIG. 11B is executed. In step S506 of the fifth display position setting process, the second display process in FIG. 14B is executed.

FIG. 14B shows a flowchart of the second display process executed in step S506. Steps S511 to S521 in the second display process correspond to steps S411 to S421 in the first display process. Steps S518 to S520 in the second display process are different from steps S418 to S420 in the first display process.

Specifically, in steps S518 to S520, the X-Y coordinates (I, J) in the memory region of the VRAM of the display device 10 is not read out from the left side to the right side, but read out from the right side to the left side. Specifically, in step S517, the Y coordinate of the index J starts from zero and ends to N−1 by adding one so that the index 3 runs from 0 to N−1 by adding one. Thus the Y coordinate runs from 0 to N−1, and is added to one at every repeat time. In step S518, the X coordinate of the index I starts from M−1 and ends to 0 by subtracting one so that the index I runs from M−1 to 0 by subtracting one. Thus the X coordinate runs from M−1 to 0 and is subtracted by one at every repeat time. Accordingly, the image data is read out from the right side to the left side by subtracting one. In step S519 the image data read out from the VRAM is displayed on the display screen from the left side to the right side.

In the navigation device according to the fifth embodiment, when the set language is the read-right-to-left language such as Arabic, the image data is read out from the memory region of the VRAM from the right side to the left side so that the image data is mirror-reversed. Accordingly, similar to the fourth embodiment it is not necessary to add a calculation process for calculating new coordinates. The process in the navigation system is rapidly performed.

In the fourth embodiment, when the item is displayed on the display region of the display device 10, the image data is mirror-reversed. In the fifth embodiment, when the image data is read out from the memory region of the VRAM, the image data is mirror-reversed. One of the process in the fifth embodiment and the process in the fourth embodiment is used according to the characteristics of the display device 10.

### Sixth Embodiment

A sixth embodiment will be explained.

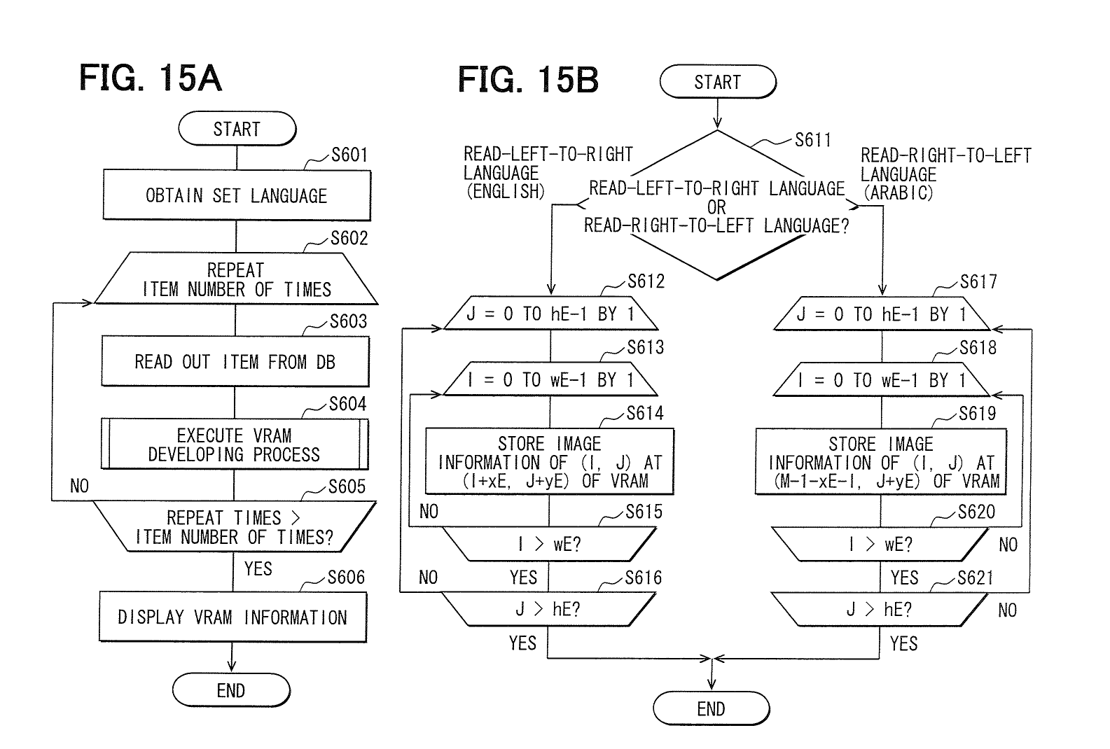

FIG. 15A shows a flowchart of a sixth display position setting process executed by the controller 8. Steps S601 to S606 in the sixth display position setting process correspond to steps S401 to S406 in the fourth display position setting process. Step S604 is different from step S404, and step S606 is different from step S406.

Specifically, in step S404 of the fourth display position setting process the image item is stored in the VRAM. In step S604 of the sixth display position setting process a VRAM developing process in FIG. 15B is executed. In step S406 of the fourth display position setting process, the image data is reversed. In step S606 of the sixth display position setting process, the image data is not reversed.

FIG. 15B shows the VRAM developing process executed in step S604 of the sixth display position setting process. In the VRAM developing process the image data in the image database of the memory 9 is reversed and stored in the memory region of the VRAM.

As shown in FIG. 12A, one of the image items has dimensions with a width of wE in the X direction and a height hE in the Y direction, and the image item is stored in the memory region of the VRAM with the upper left coordinates of (xE, yE) as a drawing origin of the item.

In step S611, the controller 8 determines whether the set language obtained in step S601 is the read-left-to-right language such as English or the read-right-to-left language such as Arabic. When the set language obtained in step S601 is the read-left-to-right language, i.e., when the determination of step S611 is “READ-LEFT-TO-RIGHT LANGUAGE,” it goes to step S612. When the set language obtained in step S601 is the read-right-to-left language, i.e., when the determination of step S611 is “READ-RIGHT-TO-LEFT LANGUAGE” it goes to step S617.

Steps S612 to S616 are process when the set language obtained in step S601 is the read-left-to-right language. Steps S613 to S615 are repeatedly executed by hE-th times in each image item in each image item. Specifically, in step S612 index J starts from zero and ends to hE-1 by adding one so that the index 3 runs from 0 to hE−1 by adding one. Thus, the Y coordinate runs from 0 to hE−1, and is added to one at every repeat time.

Further, in steps S613 to S615, step S614 is repeatedly executed by wE-th times in the same image item. Specifically, in step S613, index I starts from zero and ends to wE−1 by adding one so that the index I runs from 0 to wE−1 by adding one. Thus, the X coordinate runs from 0 to wE−1 and is added to one at every repeat time.

In step S614, the image data of the X-Y coordinates (I, J) is stored at coordinates of (I+xE, J+yE) in the memory region of the VRAM. In this case, since the language system is the normal read-left-to-right language so that it is not necessary to reverse the item, the item is displayed at the original coordinates.

Steps S617 to S621 are a process of each image item to be displayed in a case where the set language is the read-right-to-left language such as Arabic. Step S614 corresponds to step S619

Steps S618 to S620 are repeatedly executed by hE-th times. Specifically, in step S617, index 3 starts from zero and ends to hE−1 by adding one so that the index J runs from 0 to hE−1 by adding one. Further, in steps S618 to S620, step S619 is repeatedly executed by wE-th times. Specifically, in step S613, index I starts from zero and ends to wE−1 by adding one so that the index I runs from 0 to wE−1 by adding one. In step S619, the image data of the upper left coordinates of the X-Y coordinates (I, J) is not directly stored at the coordinates of (I, J) in the memory region of the VRAM but stored at the coordinates of (M−1−xE−I, J+yE) in the memory region of the VRAM. Thus, the image data is stored in the VRAM from the right side to the left side. When the image data is stored in the memory region of the VRAM from the right side to the left side, the image is reversed. When the set language is the read-right-to-left language such as Arabic, it is necessary to reverse the image item.

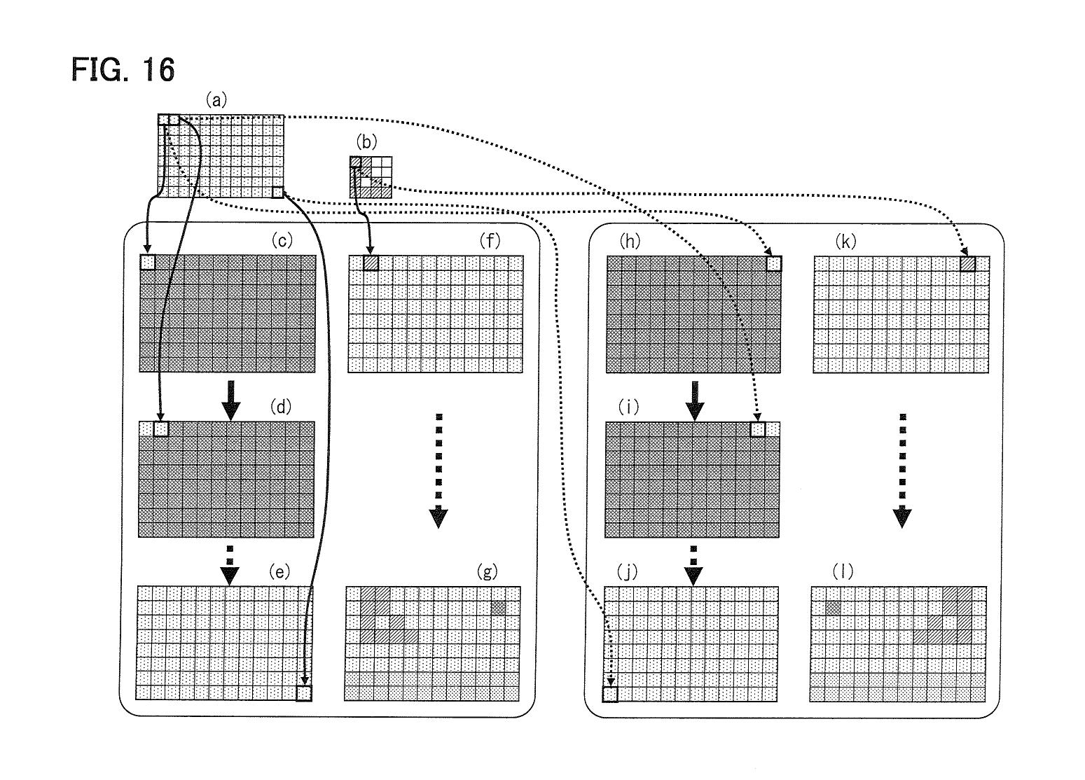

FIG. 16 shows examples of the image data stored in the memory region of the VRAM in the sixth display position setting process. (a) in FIG. 16 shows a whole area of the image, and (b) in FIG. 16 shows an example of the image item to be stored in the VRAM. (c) to (g) in FIG. 16 are the image data when the set language is the read-left-to-right language, and (h) to (l) in FIG. 16 are images data when the set language is the read-right-to-left language.

As shown in (c) in FIG. 16, the upper left coordinates in (a) in FIG. 16 is directly stored at the upper left coordinates of the memory region of the VRAM. As shown in (d) in FIG. 16, the image data is stored in the VRAM from the left side to the right side. Finally, as shown in (e) in FIG. 16, the image data in (a) in FIG. 16 is displayed directly on the screen.

Similarly, the image item shown in (b) in FIG. 16 is stored in the VRAM from the left side to the right side, as shown in (f) and (g) in FIG. 16.

On the other hand, as shown in (h) in FIG. 16, when the set language is the read-right-to-left language, the upper left coordinates in (a) in FIG. 16 is stored at the upper right coordinates of the VRAM. As shown in FIG. 16I, the item is stored in the VRAM from the right side to the left side. Finally, as shown in (j) in FIG. 16, the image data in (a) in FIG. 16 is mirror-reversed.

Similarly, the image item shown in (b) in FIG. 16 is stored in the VRAM from the right side to the left side, as shown in (k) and (l) in FIG. 16.

In the navigation system according to the sixth embodiment, when the set language is the read-right-to-left language, the image data is stored in the memory region of the VRAM from the right side to the left side so that the image data is mirror-reversed, and then displayed on the display device 10. Similar to the fourth embodiment, it is not necessary to add a calculation process for calculating new coordinates. The process in the navigation system is rapidly performed.

Although the image data is mirror reversed in the sixth embodiment when the image data is stored in the memory region of the VRAM. Alternatively, the image data may be mirror reversed, and then, the image data is read out from the right side to the left side when the image data is read out from the memory 9.

### Seventh Embodiment

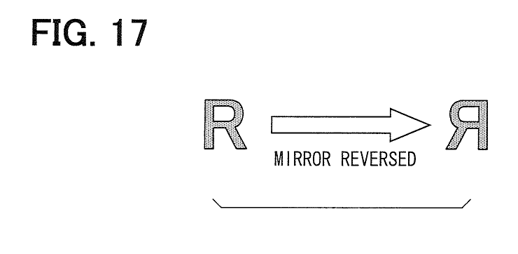

A seventh embodiment will be explained. As described above in the fourth and fifth embodiments, a whole of the image data is reversed. Accordingly, if the image item includes a character data, the character data is mirror reversed so that the character is reversed as shown in FIG. 17. Accordingly, in the seventh and eight embodiments, only a part of the image item representing a figure and/or a drawing other than the character and the sentence is mirror reversed. Further, by combining the process according to the fourth and fifth embodiments, even when the image item includes the character and/or sentence, the item is appropriately displayed on the device 10.

In the seventh embodiment, the external memory 9 includes multiple databases for storing characters.

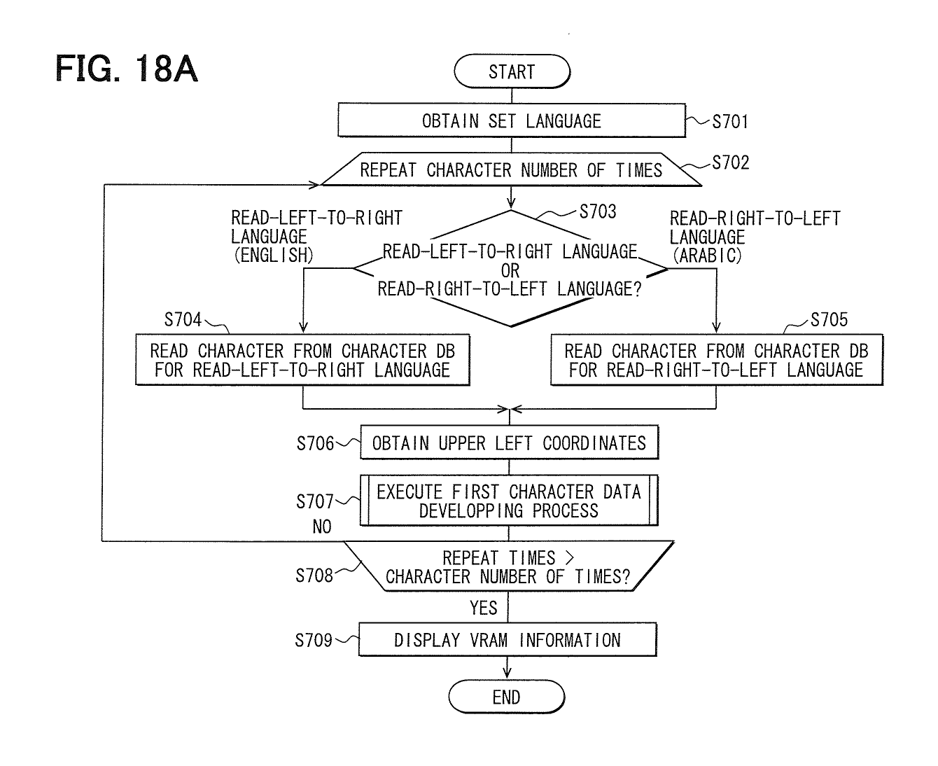

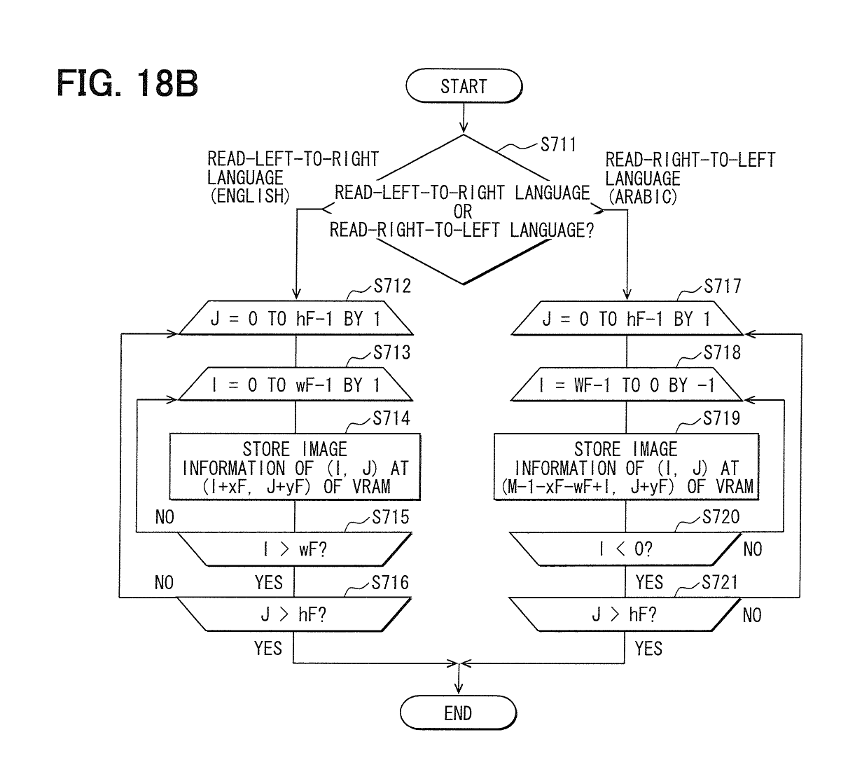

FIG. 18A shows a seventh display position setting process executed by the controller 8. FIG. 18B shows a first character data developing process. The seventh display position setting process is executed at the same timing of the first display position setting process.

Here, the character data to be displayed has a width of wF in the X direction and a height of hF in the Y direction. The upper left coordinates of the character data is defined as (xF, yF).

In step S701, similar to step S101 in the first display position setting process, the language system used for the interface environmental condition is obtained, i.e., selected.

Next, in steps S702 to S708, steps S703 to S707 are repeatedly executed the character number of times. After that, it goes to step S709.

In step S703, the controller 8 determines whether the set language obtained in step S701 is the read-left-to-right language such as English or the read-right-to-left language such as Arabic. When the set language is the read-left-to-right language, i.e., when the determination of step S703 is “READ-LEFT-TO-RIGHT LANGUAGE,” it goes to step S704. When the set language is the read-right-to-left language, i.e., when the determination of step S703 is “READ-RIGHT-TO-LEFT LANGUAGE,” it goes to step S705.

In step S704, the character data is read out from the character stored database for the read-left-to-right language in the external memory 9. Then it goes to step S706.

In step S705, the character data is read out from the character stored database for the read-right-to-left language in the external memory 9. Then it goes to step S706.

In the seventh embodiment, the memory 9 includes the character stored database for the read-left-to-right language and the character stored database for the read-right-to-left language. In accordance with the interface environmental condition, i.e., the language system, the character data is read out from one of the character stored database for the read-left-to-right language and the character stored database for the read-right-to-left language so that the character is not reversely displayed.

In step S706, the upper left coordinates of (xF, yF) of the character data to be displayed on the screen is calculated. Then, it goes to step S707. This step for calculating the upper left coordinates is similar to a case where the image item does not include a character.

In step S707, the first character data developing process shown in FIG. 18B is executed. In step S709, the information in the VRAM is displayed on the display device 10, and then, the seventh display position setting process ends.

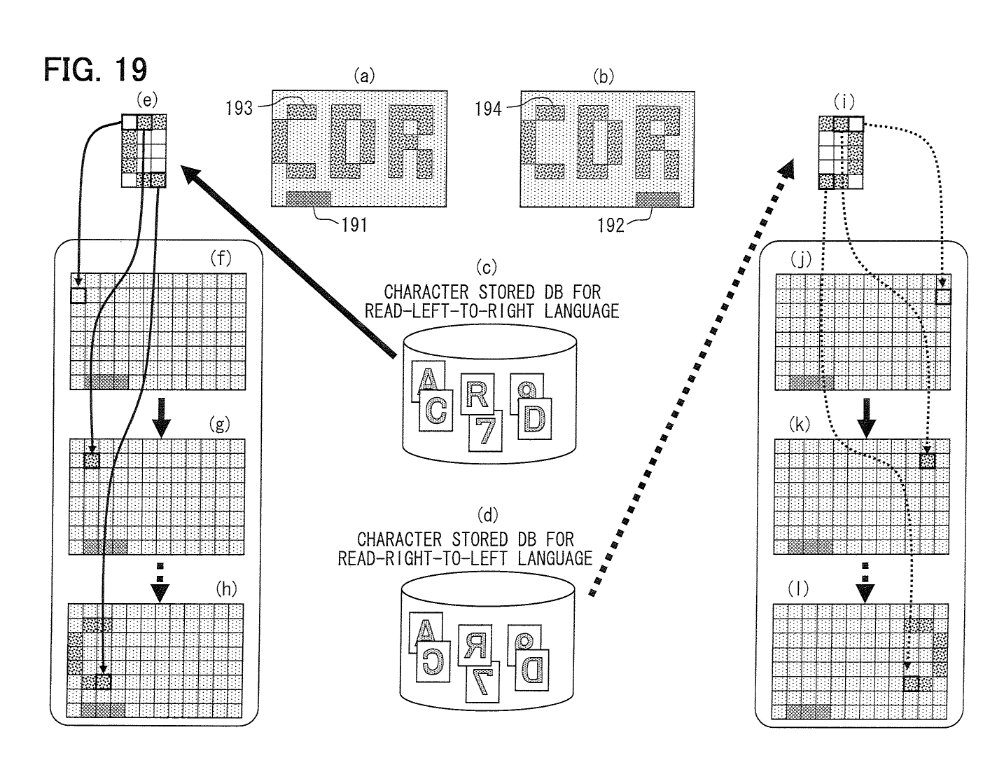

FIG. 19 shows an image data stored in the character stored database of the memory 9, which corresponds to a data in the memory region of the VRAM and an image on the display screen of the display device 10. (a) and (b) in FIG. 19 are screen images displayed on the display device 10 in a case where the language system is the read-left-to-right language or the read-right-to-left language, respectively. As shown in (b) in FIG. 19, the image item 192 is reversed and displayed when the language system is the read-right-to-left language. The character 194 is not reversed even when the language system is the read-right-to-left language.

Specifically, primary, a whole of the screen image is reversed by the process according to the fourth or fifth embodiment, and then, the character part of the screen image is further reversed so that the character part is returned to an original image. Thus, the character part is appropriately displayed on the device 10.

(c) in FIG. 19 shows the character stored database for the read-left-to-right language which stores a normal character data, i.e., an initial character data. As shown in (e) to (h) in FIG. 19, the character data is stored in the memory region of the VRAM from the left side to the right side.

On the other hand, (d) in FIG. 19 shows the character stored database for the read-right-to-left language which stores a reversed character data. The character is mirror reversed in the character stored database for the read-right-to-left language. As shown in (i) to (l) in FIG. 19, the character data is stored in the memory region of the VRAM from the right side to the left side.

FIG. 18B shows the first character data developing process executed in step S707. The character data stored in the character stored database is stored in the memory region of the VRAM.

Specifically, one of the character data has a width of wF in the X direction and a height of hF in the Y direction. The character data has the upper left coordinates as a display origin. The character data is to be stored in the memory region of the VRAM.

In step S711, the controller 8 determines whether the set language obtained in step S701 is the read-left-to-right language such as English or the read-right-to-left language such as Arabic. When the set language obtained in step S701 is the read-left-to-right language, i.e., when the determination of step S711 is “READ-LEFT-TO-RIGHT LANGUAGE,” it goes to step S712. When the set language obtained in step S701 is the read-right-to-left language, i.e., when the determination of step S711 is “READ-RIGHT-TO-LEFT LANGUAGE,” it goes to step S717.

Steps S712 to S716 are process when the set language obtained in step S701 is the read-left-to-right language. Steps S713 to S715 are repeatedly executed by hF-th times in each character data. Specifically, in step S712, index J starts from zero and ends to hF−1 by adding one so that the index 3 runs from 0 to hF−1 by adding one. Thus, the Y coordinate runs from 0 to hF−1 and is added to one at every repeat time.

Further, in steps S713 to S715 step S714 is repeatedly executed by wF-th times in the same character data. Specifically, in step S713, index I starts from zero and ends to wF−1 by adding one so that the index I runs from 0 to wF−1 by adding one. Thus the X coordinate runs from 0 to wF−1 and is added to one at every repeat time.

In step S714, the image data of the X-Y coordinates (I, J) is stored at coordinates of (I+xF, J+yF) in the memory region of the VRAM. In this case, since the language system is the normal read-left-to-right language so that it is not necessary to reverse the item, the item is displayed at the original coordinates.

Steps S717 to S721 are a process of each image item to be displayed in a case where the set language is the read-right-to-left language such as Arabic. Steps S712 to S716 correspond to steps S717 to S721. Steps S713 to S715 are different from steps S718 to S720.

Steps S718 to S720 are repeatedly executed by hF-th times in each character data. Specifically, in step S717, index J starts from zero and ends to hF−1 by adding one so that the index J runs from 0 to hF−1 by adding one. Thus, the Y coordinate runs from 0 to hF−1, and is added to one at every repeat time. Further, in steps S718 to S720, step S719 is repeatedly executed by wF-th times in the same character data. In step S718, the X coordinate of the index I starts from wF−1 and ends to 0 by subtracting one so that the index I runs from wF−1 to 0 by subtracting one. Thus, the X coordinate runs from wF−1 to 0, and is subtracted by one at every repeat time.

In step S719, the image data of the X-Y coordinates (I, J) is stored at coordinates of (M−1−xF−wF+I, J+yF) in the memory region of the VRAM. In this case since the language system is the read-right-to-left language the image is displayed from the right side to the left side. Specifically, in the seventh embodiment, since the character data is preliminary prepared for the read-right-to-left language such that the character is preliminary reversed, the character data is directly stored in the memory region of the VRAM from the right side to the left side.

Here, the character data for the read-right-to-left language is prepared by reversing an Arabic character, an English character and the like. When the character data is stored in the VRAM, the character data is directly written in the VRAM, i.e., the character data representing a reversed character is directly stored in the VRAM. With using the process according to the fourth and fifth embodiments, the character data is reversed again so that the character is appropriately displayed.

In the navigation system according to the seventh embodiment, even when the image item includes the character data the image is reversed without reversing the character.

### Eight Embodiment

An eighth embodiment will be explained. Similar to the seventh embodiment in the present embodiment, the image is reversed without reversing the character data. In the present embodiment, when the item is stored in the memory region of the VRAM, the item is written from the right side to the left side so that the character data is reversed. Then, with using the process according to the fourth or fifth embodiment, even when the image item includes the character data, the image is reversed without reversing the character.

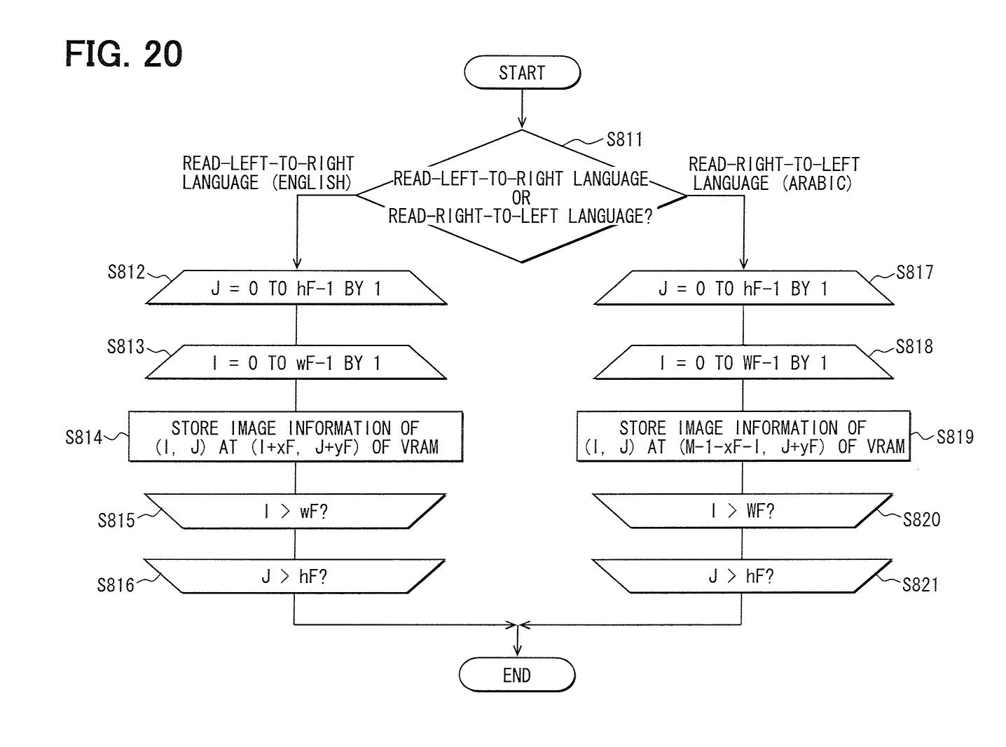

The controller 8 according to the eight embodiment executes a process similar to the fourth display position setting process in FIG. 11A. In FIG. 11A, the fourth display position setting process includes step S404. In the eight embodiment, the process includes a second character data developing process in FIG. 20 instead of step S404.

Specifically, in the present embodiment, before the image data is reversed, the character data is preliminary reversed. Then, the image data together with the reversed character data is reversed so that the character data is displayed normally.

The second character data developing process in FIG. 20 will be explained.

In step S811 the controller 8 determines whether the set language obtained in step S401 is the read-left-to-right language such as English or the read-right-to-left language such as Arabic. When the set language obtained in step S401 is the read-left-to-right language, i.e., when the determination of step S811 is “READ-LEFT-TO-RIGHT LANGUAGE,” it goes to step S812. When the set language obtained in step S401 is the read-right-to-left language, i.e., when the determination of step S811 is “READ-RIGHT-TO-LEFT LANGUAGE,” it goes to step S817.

Steps S812 to S816 are process when the set language obtained in step S401 is the read-left-to-right language. Steps S813 to S815 are repeatedly executed by hF-th times in each character data. Specifically, in step S812, index J starts from zero and ends to hF−1 by adding one so that the index 3 runs from 0 to hF−1 by adding one. Thus, the Y coordinate runs from 0 to hF−1 and is added to one at every repeat time.

Further, in steps S813 to S815 step S814 is repeatedly executed by wF-th times in the same character data. Specifically, in step S813, index I starts from zero and ends to wF−1 by adding one so that the index I runs from 0 to wF−1 by adding one. Thus the X coordinate runs from 0 to wF−1 and is added to one at every repeat time.

In step S814, the image data of the X-Y coordinates (I, J) relating to the character data is stored at coordinates of (I+xF, J+yF) in the memory region of the VRAM. In this case, since the language system is the normal read-left-to-right language so that it is not necessary to reverse the item, the item is displayed at the original coordinates.

Steps S817 to S821 are a process of each image item to be displayed in a case where the set language is the read-right-to-left language such as Arabic. Steps S812 to S816 correspond to steps S817 to S821. Step S814 is different from step S819.

Steps S818 to S820 are repeatedly executed by hF-th times in each character data. Specifically, in step S817, index 3 starts from zero and ends to hF−1 by adding one so that the index 3 runs from 0 to hF−1 by adding one. Thus, the Y coordinate runs from 0 to hF−1, and is added to one at every repeat time. Further, in steps S818 to S820, step S819 is repeatedly executed by wF-th times in the same character data. In step S818, the X coordinate of the index I starts from 0 and ends to wF−1 by adding one so that the index I runs from 0 to wF−1 by adding one. Thus, the X coordinate runs from 0 to wF−1, and is added to one at every repeat time.

In step S819, the image data of the X-Y coordinates (I, J) relating to the character data is stored at coordinates of (M−1−xF−I, J+yF) in the memory region of the VRAM. In this case, since the language system is the read-right-to-left language, the character data is reversed, and then, the image is displayed from the right side to the left side. Specifically, in the eight embodiment, since the character data is not preliminary prepared for the read-right-to-left language such that the character is preliminary reversed, the character data is reversed, and then, stored in the memory region of the VRAM from the right side to the left side. Specifically, since the database for the read-right-to-left language is the same as the database for the read-left-to-right language, the character data is reversed, and then, stored in the VRAM from the right side to the left side.

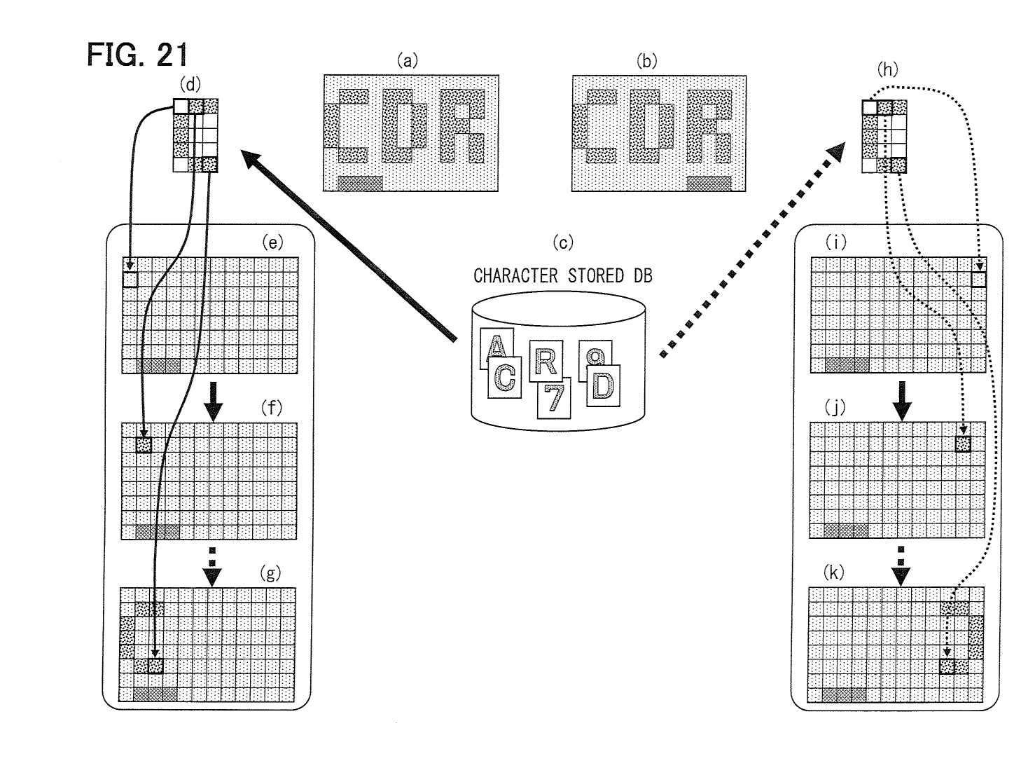

FIG. 21 shows image data stored in the character stored database of the memory 9, which corresponds to a data in the memory region of the VRAM and an image on the display screen of the display device 10. (a) and (b) in FIG. 21 are screen images displayed on the display device 10 in a case where the language system is the read-left-to-right language or the read-right-to-left language, respectively. (a) and (b) in FIG. 21 correspond to (a) and (b) in FIG. 19. As shown in (b) in FIG. 21, the image item 192 is reversed and displayed when the language system is the read-right-to-left language. The character 194 is not reversed even when the language system is the read-right-to-left language.

(c) in FIG. 21 shows the character stored database for storing only the character data for the read-left-to-right language, which stores a normal character data, i.e., an initial character data.

When the language system is the read-left-to-right language, as shown in (d) to (g) in FIG. 21, the image data is stored in the memory region of the VRAM from the left side to the right side. When the language system is the read-right-to-left language as shown in (h) and (k) in FIG. 21, the image data is stored in the memory region of the VRAM from the right side to the left side so that the image data is reversed.

In the navigation system according to the eighth embodiment, even when the image item includes the character data, the image can be reversed without display the reversed character.

### Other Embodiments

Although the display position setting device is in the navigation system the display position setting device may be in a personal computer, a cell Phone a smart phone or the like, which has a display panel for displaying the image.

Although the environmental conditions include information about the language system information about a position of a steering wheel, or information about the sunlight reflection position the environmental condition may include information about night time and day time, information about the season, information about time, information about hobby of the user, information about preference of the user, information about specialization area of the user or the like.

In the fourth to eighth embodiments, the controller 8 executes a process such that the image data is reversed. Alternatively, a part of the process for reversing the image data may be performed by a processor in the display device 10. Alternatively, a part of the process for reversing the image data may be performed by a device, which is coupled with the controller via a network.

A method for mirror reversing the image data may be a method for reading out the image data from the right side to the left side in the memory 9. Alternatively, when the navigation system further includes a memory region other than the VRAM, the image data may be stored in the memory region other than the VRAM or may be read out from the memory region other than the VRAM so that the image data is mirror reversed.

In the above embodiments, the reading out direction from the memory 9, the storing direction into the VRAM, the reading out direction from the VRAM, and the displaying direction on the display screen of the display device 10 are normally from the left side to the right side. Alternatively, the reading out direction from the memory 9, the storing direction into the VRAM, the reading out direction from the VRAM, and the displaying direction on the display screen of the display device 10 may be normally from the right side to the left side.

The above disclosure has the following aspects.

According to a first aspect of the present disclosure a display position setting device includes: an obtaining element for obtaining positioning condition information, which provides an arrangement of an image item on a screen of a display device according to an interface condition wherein the image item is a batch of various information; a reading element for reading out the image item together with content information and position information from a memory, wherein the content information provides content of the image item, and the position information provides a position of the image item on the screen of the display device a converting element for converting the position information based on the positioning condition information; and a display controller for controlling the display device to display the content information at a position, which is specified by converted position information.

Here, the interface condition means extrinsic circumstances, which affect the arrangement of various information on the screen of the display device. For example, the interface condition is a language system, a position of a steering wheel such as a right hand steering wheel or a left hand steering wheel when the display position setting device is disposed in an in-vehicle navigation system, and a sunlight reflection position on the screen of the display device at which the sunlight reflects so that it is difficult for an user to see the screen.

The image item means all of elements each of which provides the batch of information for providing various information. For example, the elements are an image such as an icon, a text data representing a character and/or a sentence, a figure and a picture. The image item is arranged at a position on the screen of the display device specified by the position information.

In the above display position setting device since the position information is reset, i.e., converted according to the positioning condition information, it is not necessary to store a large amount of position information corresponding to the image items. Thus, without increasing the area of use of the memory, the image item is arranged on the screen according to the interface condition.

A condition whether the language system is the read-left-to-right language or the read-right-to-left language affects the arrangement of the image item. Specifically, when the interface condition includes the condition that the language system is the read-right-to-left language, it is preferred that the image item is arranged in view of a fact that the user moves his visual line from the right side to the left side.

Thus, the positioning condition information may include a language condition that shows whether a language system is a read-left-to-right language or a read-right-to-left language. The converting element converts a horizontal coordinate of the screen in the position information with respect to a part of or a whole of the image item. In this case, even when the language system is the read-right-to-left language or the read-left-to-right language, without increasing the area of use of the memory, the image item is arranged on the screen according to the interface condition.

In some image items, it is not necessary to rearrange the items on the screen. Thus, in this case, it is not appropriate to reset the arrangement of the items.

Thus, the image item may further include flag information that shows whether the position information is converted or not, and the converting element converts the position information of the image item, which includes the flag information showing that the position information is converted. In this case, when it is not necessary to rearrange the image item on the screen, the item is not rearranged. Thus according to the interface condition the image item is appropriately displayed on the screen.

Further, when the display position setting device is mounted on the navigation system, the interface condition may, include a condition that the vehicle is a right hand steering wheel vehicle or a left hand steering wheel vehicle. Specifically, it is preferable for the user to change the arrangement of the item to be mirror reversed when the user operates the navigation system. For example, when the vehicle is the left hand steering wheel vehicle, the user can easily operate the left side of the navigation system.

Thus, the display position setting device may be disposed in an in-vehicle navigation system. The position condition information includes steering wheel information that shows whether a steering wheel of a vehicle is disposed on a right side of the vehicle or a left side of the vehicle, and the converting element converts a horizontal coordinate of the screen in the position information with respect to a part of or a whole of the image item based on the steering wheel information. In this case, the arrangement of, for example, an operation button as the image item displayed on the screen of the display device is changed according to the condition that the vehicle is the right hand steering wheel vehicle or the left hand steering wheel vehicle. Thus the operability of the navigation system is improved. For example, when the vehicle is the left hand steering wheel vehicle a most frequently used switch is arranged on the left side of the screen of the display device, so that the operability for the user is improved.

In the navigation system, when the screen of the display device is exposed to the sunlight so that the screen includes a reflection portion and a shaded portion. It is difficult for the user to see the reflection portion of the screen. Thus, it is not Preferable to display various information on the reflection portion of the screen.

Thus, the display position setting device may be disposed in an in-vehicle navigation system. The position condition information includes sunlight information that shows a sunlight reflection position on the screen of the display device. The sunlight reflection position on the screen is not viewable for a user, and the converting element converts the position information so as to display the image item at a position other than the sunlight reflection position with respect to a part of or a whole of the image item based on the sunlight information. In this case, the image item is arranged on the screen to avoid the sunlight reflection position, so that the user can easily see the screen.

Since the arrangement of the image item is calculated according to the interface condition, a process time for calculating the arrangement may be long.

Thus according to a second aspect of the present disclosure a position setting device includes: an image information obtaining element for obtaining image information; a display direction information obtaining element for obtaining display direction information which shows whether the image information is directly displayed on a display device, or mirror reversed and displayed on the display device; and a display controller for controlling the display device to display the image information along with a direction specified by the display direction information.

In the above device even when the language system is the read-right-to-left language, it is not necessary to add a calculation process for calculating new coordinates. Thus, the device can execute a display position setting process with high speed.

Alternatively, the display position setting device may further include: a VRAM for temporally storing the image information. The display controller controls the VRAM to store the image information into a memory region of the VRAM. The display controller reads out a plurality of pixel data units, which provide an image in the image information, from the memory region of the VRAM. The display controller controls the display to display the image on a screen of the display device. A reading position of each pixel data unit at the memory region of the VRAM is mirror reversed to a display position of the pixel data unit on the screen of the display device so that the image is mirror reversed and displayed on the screen of the display device.

In the above device, even when the language system is the read-right-to-left language it is not necessary to add a calculation process for calculating new coordinates. Thus, the device can execute a display position setting process with high speed.

Alternatively, the display controller may read out each pixel data unit from the VRAM along with a normal direction, and the display controller controls the displayed device to display each pixel data unit on the screen along with a direction mirror reversed to the normal direction so that the reading position of the pixel data unit from the VRAM is mirror reversed to the display position of the pixel data unit on the screen. In this case, the reading position of the image data from the VRAM is reversed to the display position on the screen. In the above device, even when the language system is the read-right-to-left language, it is not necessary to add a calculation process for calculating new coordinates. Thus the device can execute a display position setting process with high speed.

Alternatively, the display controller may read out each pixel data unit from the VRAM along with a direction mirror reversed to a normal direction, and the display controller controls the displayed device to display each pixel data unit on the screen along with the normal direction so that the reading position of the pixel data unit from the VRAM is mirror reversed to the display position of the pixel data unit on the screen. In this case, the reading position of the image data from the VRAM is reversed to the display position on the screen. In the above device even when the language system is the read-right-to-left language, it is not necessary to add a calculation process for calculating new coordinates. Thus, the device can execute a display position setting process with high speed.

When the image is mirror reversed and displayed on the screen, and the image item includes a character, the character is also reversed.

Thus, the image information obtaining may obtain the image information with character information when the display direction information obtaining element obtains the display direction information that the image information is mirror reversed and displayed on the display device, and the image information includes the character information and the character information provides a character image, which is preliminary mirror reversed. In this case, even when the image item includes character information the character is not reversed but displayed normally.

Alternatively, the display controller may mirror reverse character information and controls the VRAM to store mirror reversed character information in a memory region of the VRAM when the display direction information obtaining element obtains the display direction information that the image information is mirror reversed and displayed on the display device, and the image information includes the character information and the character information provides a character image. In this case, the character is displayed normally. In this case, even when the image item includes character information, the character is not reversed but displayed normally.

Alternatively, the display position setting device may further include: a VRAM for temporally storing the image information. The display controller controls the VRAM to store a plurality of pixel data units into a memory region of the VRAM. The plurality of pixel data units provide an image in the image information. The display controller reads out each pixel data unit from the memory region of the VRAM. The display controller controls the display to display the image on a screen of the display device. A storing position of each pixel data unit in the memory region of the VRAM is mirror reversed to an obtaining position of the image information by the image information obtaining element so that the image is mirror reversed and displayed on the screen of the display device when the display direction information obtaining element obtains the display direction information that the image information is mirror reversed and displayed on the display device. In this case, even when the image item includes character information, the character is not reversed but displayed normally.

Alternatively, the display controller may obtain the image information along with a normal direction and the display controller controls the VRAM to store the image information along with a direction mirror reversed to the normal direction so that the storing position of each pixel data unit in the memory region of the VRAM is mirror reversed to the obtaining position of the image information by the image information obtaining element. In this case, even when the image item includes character information the character is not reversed but displayed normally.

While the invention has been described with reference to preferred embodiments thereof, it is to be understood that the invention is not limited to the preferred embodiments and constructions. The invention is intended to cover various modification and equivalent arrangements. In addition, while the various combinations and configurations, which are preferred, other combinations and configurations including more less or only a single element, are also within the spirit and scope of the invention.

What is claimed is:

1. A display position setting device comprising:
an obtaining element for obtaining positioning condition information, which provides an arrangement of an image item on a screen of a display device according to an interface condition wherein the image item is a batch of various information;
a reading element for reading out the image item together with content information and position information from a memory, wherein the content information provides content of the image item and the position information provides a position of the image item on the screen of the display device;
a converting element for converting the position information based on the positioning condition information; and
a display controller for controlling the display device to display the content information at a position which is specified by converted position information.

2. The display position setting device according to claim 1,
wherein the positioning condition information includes a language condition that shows whether a language system is a read-left-to-right language or a read-right-to-left language and
wherein the converting element converts a horizontal coordinate of the screen in the position information with respect to a part of or a whole of the image item.

3. The display position setting device according to claim 1,
wherein the image item further includes flag information that shows whether the position information is converted or not, and
wherein the converting element converts the position information of the image item, which includes the flag information showing that the position information is converted.

4. The display position setting device according to claim 1,
wherein the display position setting device is disposed in an in-vehicle navigation system,
wherein the position condition information includes steering wheel information that shows whether a steering wheel of a vehicle is disposed on a right side of the vehicle or a left side of the vehicle, and
wherein the converting element converts a horizontal coordinate of the screen in the position information with respect to a part of or a whole of the image item based on the steering wheel information.

5. The display position setting device according to claim 1,
wherein the display position setting device is disposed in an in-vehicle navigation system,
wherein the position condition information includes sunlight information that shows a sunlight reflection position on the screen of the display device,
wherein the sunlight reflection position on the screen is not viewable for a user, and
wherein the converting element converts the position information so as to display the image item at a position other than the sunlight reflection position with respect to a part of or a whole of the image item based on the sunlight information.

6. A display position setting device comprising:
an image information obtaining element for obtaining image information;
a display direction information obtaining element for obtaining display direction information which shows whether the image information is directly displayed on a display device or mirror reversed and displayed on the display device; and
a display controller for controlling the display device to display the image information along with a direction specified by the display direction information.

7. The display position setting device according to claim 6 further comprising:
a VRAM for temporally storing the image information,
wherein the display controller controls the VRAM to store the image information into a memory region of the VRAM,
wherein the display controller reads out a plurality of pixel data units, which provide an image in the image information from the memory region of the VRAM,
wherein the display controller controls the display to display the image on a screen of the display device and
wherein a reading position of each pixel data unit at the memory region of the VRAM is mirror reversed to a display position of the pixel data unit on the screen of the display device so that the image is mirror reversed and displayed on the screen of the display device.

8. The display position setting device according to claim 7,
wherein the display controller reads out each pixel data unit from the VRAM along with a normal direction, and
wherein the display controller controls the displayed device to display each pixel data unit on the screen along with a direction mirror reversed to the normal direction so that the reading position of the pixel data unit from the VRAM is mirror reversed to the display position of the pixel data unit on the screen.

9. The display position setting device according to claim 7,
wherein the display controller reads out each pixel data unit from the VRAM along with a direction mirror reversed to a normal direction, and
wherein the display controller controls the displayed device to display each pixel data unit on the screen along with the normal direction so that the reading position of the pixel data unit from the VRAM is mirror reversed to the display position of the pixel data unit on the screen.

10. The display position setting device according to claim 7,
wherein the image information obtaining obtains the image information with character information when the display direction information obtaining element obtains the display direction information that the image information is mirror reversed and displayed on the display device and the image information includes the character information and
wherein the character information provides a character image, which is preliminary mirror reversed.

11. The display position setting device according to claim 7,
wherein the display controller mirror reverses character information and controls the VRAM to store mirror reversed character information in a memory region of the VRAM when the display direction information obtaining element obtains the display direction information that the image information is mirror reversed and displayed on the display device and the image information includes the character information and
wherein the character information provides a character image.

12. The display position setting device according to claim 6 further comprising:
a VRAM for temporally storing the image information
wherein the display controller controls the VRAM to store a plurality of pixel data units into a memory region of the VRAM,
wherein the plurality of pixel data units provide an image in the image information,
wherein the display controller reads out each pixel data unit from the memory region of the VRAM,
wherein the display controller controls the display to display the image on a screen of the display device, and
wherein a storing position of each pixel data unit in the memory region of the VRAM is mirror reversed to an obtaining position of the image information by the image information obtaining element so that the image is mirror reversed and displayed on the screen of the display device when the display direction information obtaining element obtains the display direction information that the image information is mirror reversed and displayed on the display device.

13. The display position setting device according to claim 12,
wherein the display controller obtains the image information along with a normal direction and
wherein the display controller controls the VRAM to store the image information along with a direction mirror reversed to the normal direction so that the storing position of each, pixel data unit in the memory region of the VRAM is mirror reversed to the obtaining position of the image information by the image information obtaining element.
